(19) United States
(12) Patent Application Publication
(10) Pub. No.: US 2019/0104415 A1
(43) Pub. Date: Apr. 4, 2019

(54) INTERNET OF THINGS SOFTWARE SECURITY CONFIGURATION

(71) Applicant: PCMS Holdings, Inc., Wilmington, DE (US)

(72) Inventor: Christian M. Gehrmann, Lund (SE)

(73) Assignee: PCMS Holdings, Inc., Wilmington, DE (US)

(21) Appl. No.: 16/086,420

(22) PCT Filed: Mar. 22, 2017
(86) PCT No.: PCT/US2017/023532

§ 371 Date: Sep. 19, 2018

Related U.S. Application Data
(60) Provisional application No. 62/316,868, filed on Apr. 1, 2016.

(51) Int. Cl. H04W 12/12; H04W 12/10; H04W 12/08; G06F 21/57; G06F 8/65; G06F 11/14

(52) U.S. Cl. CPC H04W 12/12; H04W 12/1008; H04W 12/08; H04L 9/3247; G06F 8/65; G06F 11/1433; G06F 21/577

(57) ABSTRACT

Systems, methods, and instrumentalities are disclosed for providing security to a wireless transmit receive unit (WTRU). A software vulnerability ticket (SVT) may be received by a WTRU. The SVT may include a location to fetch software update information, content of the software update information, and/or an indication that an update is not available. The SVT may be stored in a memory associated with the WTRU. It may be determined (e.g., by a security agent associated with the WTRU) whether the WTRU has a fresh SVT. A security agent may run in a secure execution environment on the WTRU. The secure execution environment may not be dependent on a main operating system associated with the WTRU. If it is determined that the WTRU has a fresh SVT, a security update may be performed. If it is determined that the WTRU does not have a fresh SVT, a recovery procedure may be executed.

### CROSS-REFERENCE

This application claims the benefit of U.S. Provisional Application No. 62/316,868 filed on Apr. 1, 2016, which is incorporated herein by reference as if fully set forth.

### BACKGROUND

In the future, one or more devices (e.g., Internet of thing (IoT) units) may perform security critical tasks in systems for industry process control, building automation, power control, and healthcare. The correct operation of these devices may be needed (e.g., to maintain security) for the robustness of the system, etc. For example, failure of a component can result in severe consequences. However, vulnerabilities may be hard to predict and attacks may arise on network embedded systems (e.g., zero-day vulnerabilities).

### SUMMARY

Systems, methods, and instrumentalities are disclosed for providing security to a wireless transmit receive unit (WTRU). The WTRU may receive software vulnerability tickets (SVTs) and store the SVTs in a memory associated with the WTRU. A security agent may be associated with the WTRU and may run in a secure execution environment of the WTRU. The secure execution environment may not be dependent on a main operating system associated with the WTRU. The security agent may determine whether the WTRU has a fresh SVT. If it is determined that the WTRU has a fresh SVT, the WTRU may perform a security update. If it is determined that the WTRU does not have a fresh SVT, the WTRU may execute a recovery procedure.

For example, an SVT may be received by a WTRU. The SVT may include a software update, such as software update information. The software update information may include software patches, security patches, software configuration updates, software vulnerability signatures, etc. The SVT may include a location to fetch software update information (e.g., a location to fetch software patches, security patches, software configuration updates, software vulnerability signatures, etc.), a content of the software update information, and/or an indication that no updates are associated with the SVT. The SVT may be stored in a memory associated with the WTRU. It may be determined (e.g., by a security agent associated with the WTRU), whether the WTRU has a fresh SVT. A security agent may run in a secure execution environment on the WTRU. The secure execution environment may not be dependent on a main operating system associated with the WTRU. If it is determined that the WTRU has a fresh SVT, a security update may be performed. If it is determined that the WTRU does not have a fresh SVT, a recovery procedure may be executed.

The security agent may determine that the WTRU has the fresh SVT when it is determined that a latest stored SVT was received within a predefined threshold time period and/or was received according to a predefined sequence. The security agent may determine that the WTRU does not have a fresh SVT when it is determined that a latest stored SVT may not be received within a predefined threshold time period, the SVT was not received according to a predefined sequence, and/or that the WTRU does not have a stored SVT. The SVT may include a location to fetch software update information and/or a content of the software update information. The SVT may include a time stamp of the SVT, an identification number of the SVT, and/or one or more signatures of vulnerabilities. The SVT may include a digital signature of the sender of the SVT. The digital signature may include a public key algorithm and/or a private key of the sender of the SVT. The recovery procedure may include the WTRU retrieving the fresh SVT. Retrieving the fresh SVT may include the security agent and/or a non-secure portion of the WTRU accessing a network to retrieve the fresh SVT.

### BRIEF DESCRIPTION OF THE DRAWINGS

FIG. 1 is a diagram of an example domain in which an attack may occur.

FIG. 2 is a diagram of an example unit upgrade procedure.

FIG. 3 is a diagram of an example patch management.

FIG. 4 is a diagram of an example device recovery.

FIG. 5 is a diagram of an example SW Vulnerability Ticket (SVT) distribution.

FIG. 6 is a diagram of an example Multicast SVT distribution.

FIG. 7 is a diagram of an example Relay server based SVT distribution.

FIG. 8 is a diagram of an example Device Management System (DMS) fetch based SVT distribution.

FIG. 9 is a diagram of an example SVT fetch and write feature for TZ base Security Agent (SA) implementation.

FIGS. 10A, 10B are flow diagrams of an example SVT collection and processing.

FIG. 11 is a diagram of an example virtualization based SW implementation.

FIG. 12 is a diagram of an example TZ based implementation.

FIG. 13 is a diagram of an example platform dual boot-based implementation.

FIG. 14 is a diagram of an example automotive scenario.

FIG. 15A is a system diagram of an example communications system in which one or more disclosed embodiments may be implemented.

FIG. 15B is a system diagram of an example wireless transmit/receive unit (WTRU) that may be used within the communications system illustrated in FIG. 15A.

FIG. 15C is a system diagram of an example radio access network and an example core network that may be used within the communications system illustrated in FIG. 15A.

FIG. 15D is a system diagram of another example radio access network and an example core network that may be used within the communications system illustrated in FIG. 15A.

FIG. 15E is a system diagram of another example radio access network and an example core network that may be used within the communications system illustrated in FIG. 15A.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application. In addition, the figures may illustrate one or more message charts, which are meant to be exemplary. Other embodiments may be used. The order of the messages may be varied where appropriate. Messages may be omitted if not needed, and, additional messages may be added.

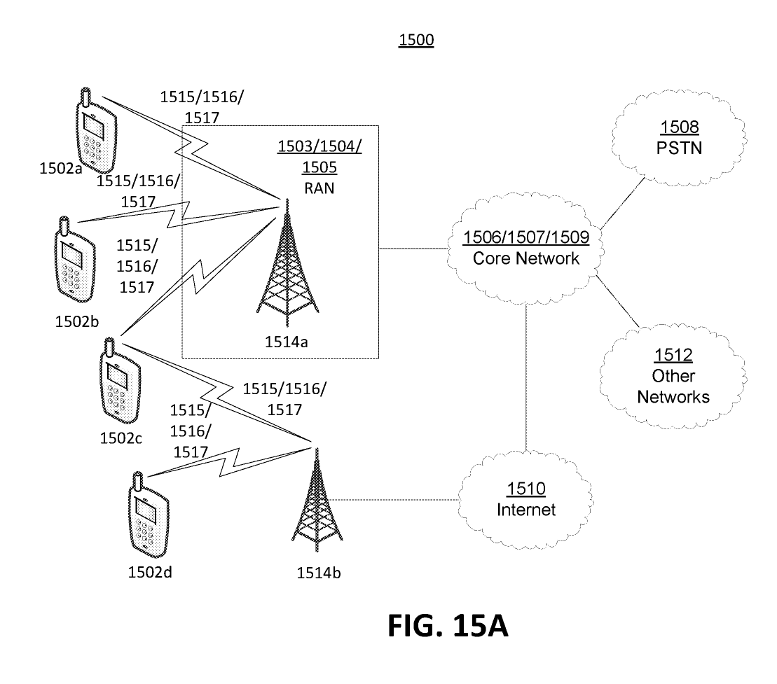

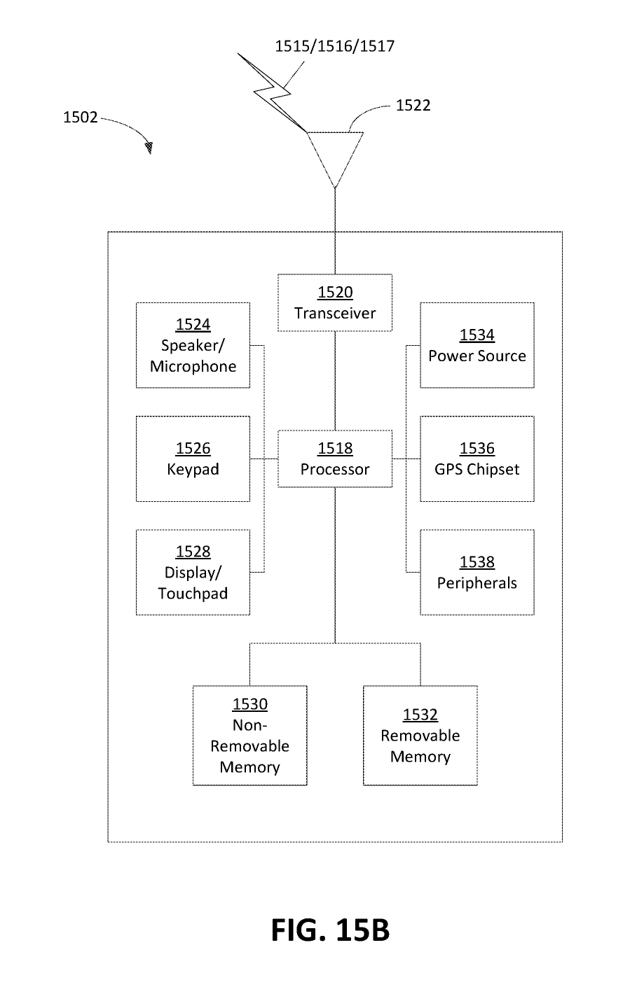

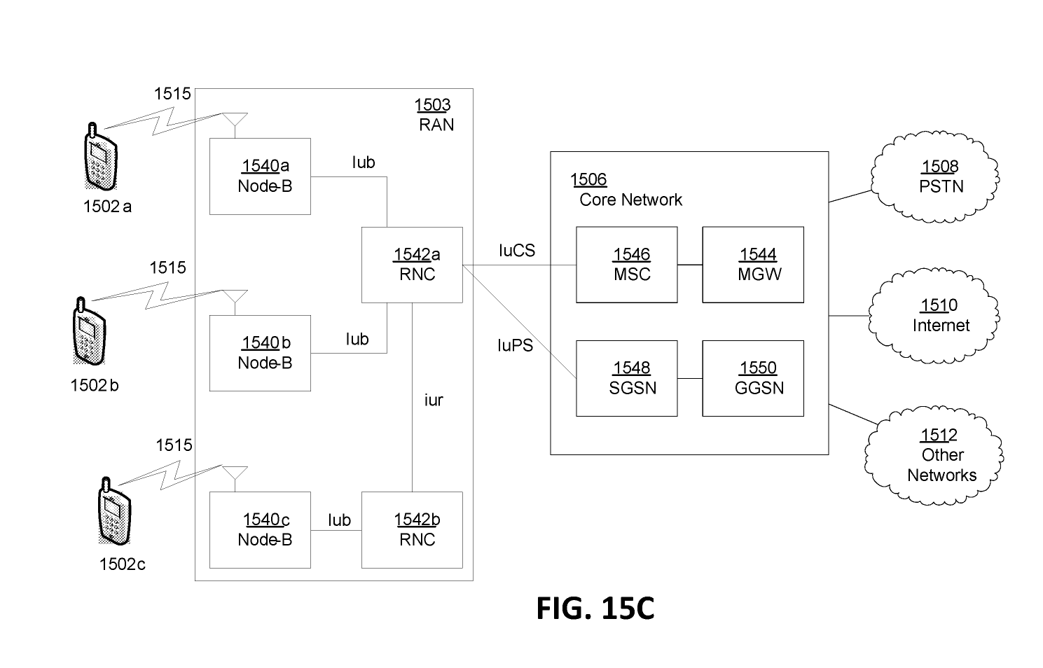

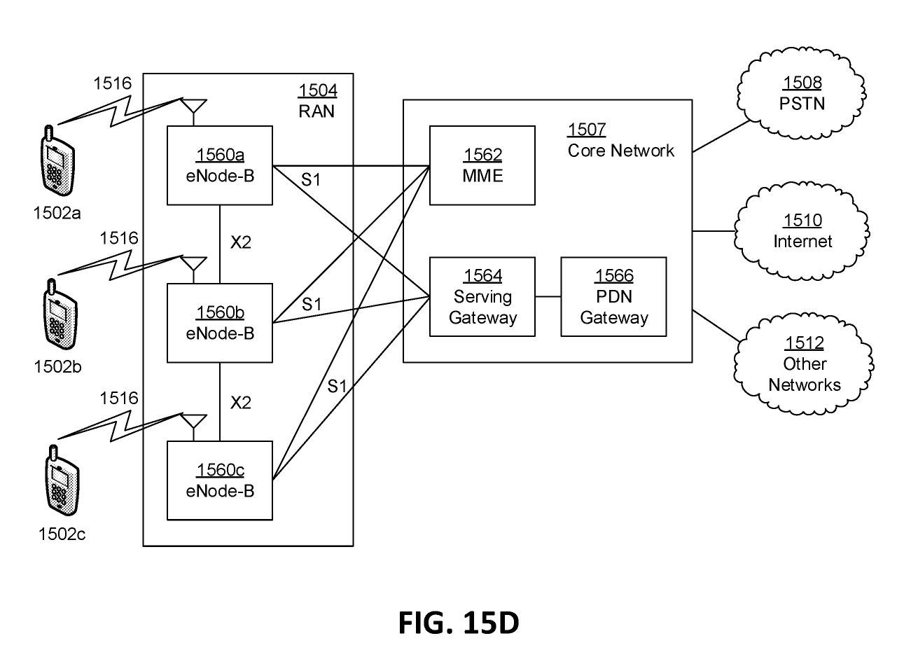

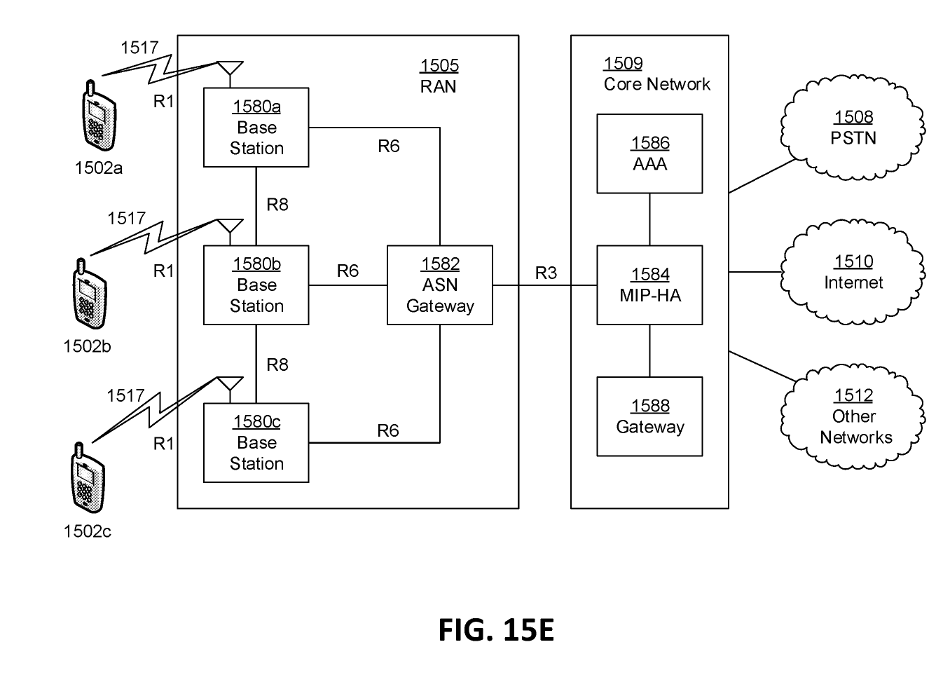

Examples herein may be illustrated with reference to a wireless transmit/receive unit (WTRU). A WTRU may be an Internet of Things (IoT) unit or an machine to machine (M2M) unit. An IoT unit or M2M unit may have the functionality of a WTRU, for example, as described in FIG. 15B. An IoT unit or M2M unit may be a limited power device or resource constrained device as compared to other exemplary WTRUs (e.g., personal computer, smartphone, etc.).

It may be difficult to keep IoT devices (e.g., a large number of IoT devices) robust against new software (SW) vulnerabilities. SW freshness tickets may be issued (e.g., regularly issued) by central IoT management systems to keep IoT devices robust against new software (SW) vulnerabilities. The tickets may be used by a secure compartment and/or by an execution environment on the IoT device. For example, the tickets may be used by a secure compartment and/or by an execution environment on the IoT device to ensure that the device has the latest SW vulnerability information and/or to ensure that the system is robust against the latest know vulnerabilities that may affect the device. The secure execution environment and/or the secure compartment (e.g., only the secure execution environment and/or the secure compartment) may be dependent on a secure watchdog timer for maintaining the node security. The secure execution environment and/or the secure compartment (e.g., only the secure execution environment and/or the secure compartment) may be dependent on access to the tickets issued by the IoT infrastructure owner for maintaining the device security. The solution may avoid being dependent on network connectivity (e.g., continuous network connectivity) from the secure compartment and the secure execution environment.

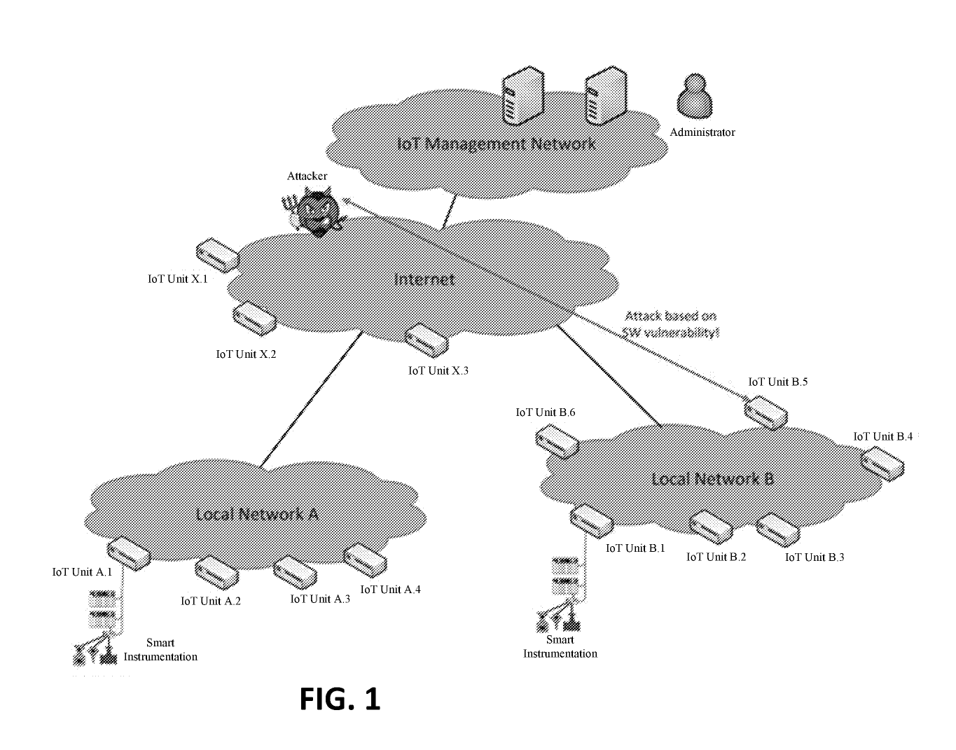

Security and/or configuration updates may be performed in one or more ways. For example, security and/or configuration updates may be performed in one or more ways to problem domains, such as an example problem domain shown in FIG. 1. Security and/or configuration updates may be performed by update checks. For example, security and/or configuration updates may be performed by automated update checks handled locally on a computing unit by the OS. Security and/or configuration updates may be performed with centrally managed updating tools connected to one or more databases to schedule and upgrade the complete system. For example, security and/or configuration updates may be performed with centrally managed updating tools connected to one or more databases that collaborate with local upgrading agents on the units to schedule and upgrade the complete system.

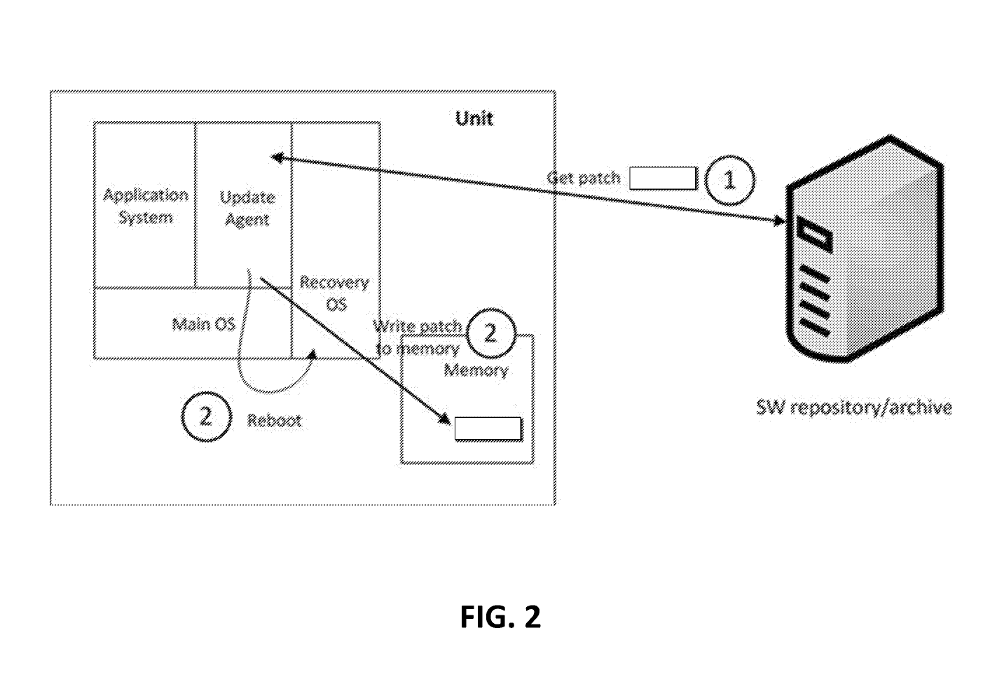

An operating system and/or other software (SW) package may be updated and/or may comprise software update information in one or more ways. Software update information may include software patches, security patches, software configuration updates, software vulnerability signatures, etc. Software update information may include binary and/or string pattern software that may be used to detect the presence of undesired (e.g., harmful) software on the IoT device. For example, it may be determined that an operating system and/or other software (SW) package may comprise the latest software update information (e.g., the latest software patches, security patches, software configuration updates, software vulnerability signatures, etc.). A way to ensure that an operating system and/or other software (SW) packages may be up to date and/or may comprise security patches (e.g., the latest security patches) may be to run a SW upgrade agent on the computing units that may be desired to be protected. FIG. 2 shows an example of running a SW update agent on a computing unit that is desired to be protected. One or more SW upgrade agents may run (e.g., automatically run) and may look for available SW upgrades on regular time bases. The agents may be controlled (e.g., controlled manually) through an application interface and/or by commands (e.g., command prompt commands). At system upgrade, the system may need to be rebooted. For example, depending on the type of upgrade that may apply, at system upgrade the system may need to be rebooted. If a reboot applies, the system may utilize a recovery OS that may be booted and/or may upgrade the main system. For example, if a reboot applies, the system may utilize a recovery OS that may be booted and/or may upgrade the main system before the system is restarted in Normal mode.

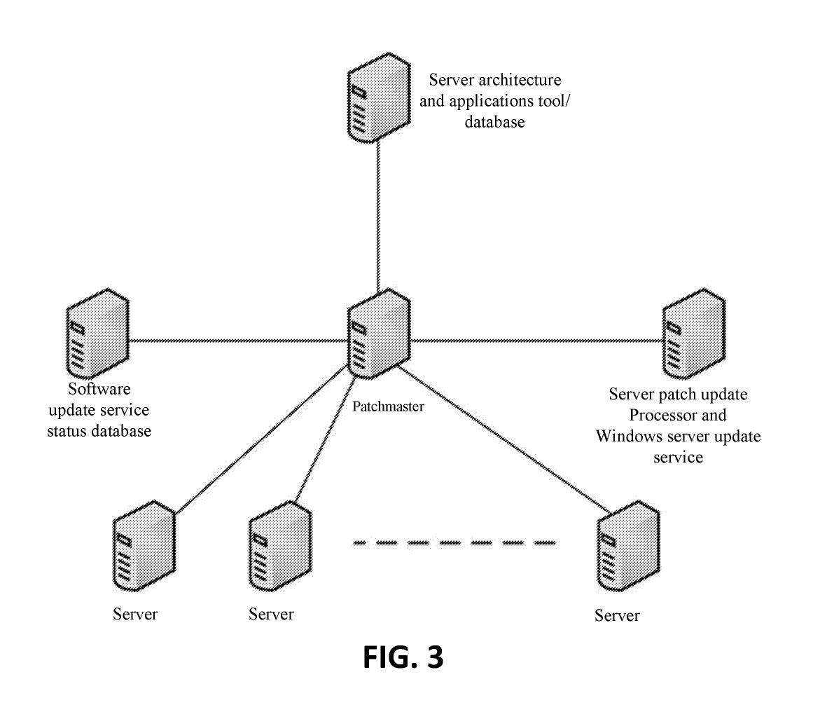

FIG. 3 may describe a system for centrally controlling a SW upgrade of services using a patchmaster unit that may be responsible for interacting with update agents on one or more servers. For example, FIG. 3 may describe a system for centrally controlling a SW upgrade of one or more services using a patchmaster unit that may be responsible for interacting with update agents on one or more Windows servers.

Patch management may include one or more of the following. Patch management may include keeping a separate database of servers in the system, and/or by keeping a separate database of the configurations and/or applications of the servers. Patch management may include grouping servers into filtering groups For example, patch management may include grouping servers into filtering groups where one or more servers within a group may share patch characteristics and/or needs. Patch management may include letting an agent on the servers scan the server and/or sending the information to the patchmaster. For example, patch management may include letting an agent on the servers scan the server for the local SW status and/or sending the information to the patchmaster. Patch management may include scheduling SW patching and/or reboot of the servers in the system. For example, patch management may include scheduling at the patchmaster (such as under supervision of an administrator manager) SW patching and/or reboot of the servers in the system. Patch management may include sending patch and/or update commands from the patchmaster to one or more servers. For example, patch management may include sending patch and/or update commands from the patchmaster to one or more servers subject to upgrade.

Semi-automated or fully-automated SW configuration and/or patch of one or more servers may be provided. For example, semi-automated or fully-automated SW configuration and/or patch of one or more Windows servers may be provided.

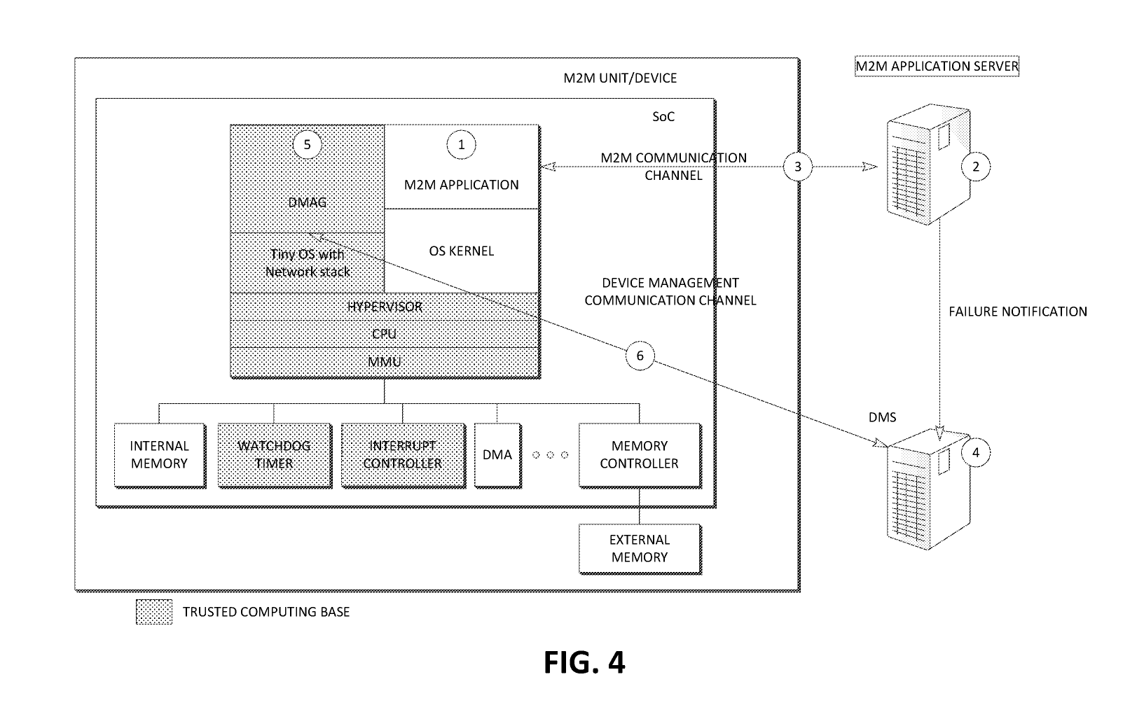

An implementation for secure recovery of devices using virtualization may be described. For example, an implementation for secure recovery of devices for M2M units, using virtualization, may be described. An example feature of secure recovery for M2M units using virtualization is depicted in FIG. 4. The system may assume a Device Management Agent (DMAG). The DMAG may be running in a secure virtualized execution environment in the system. A scheduled execution of the DMAG may be forced. The scheduled execution of the DMAG may be forced through hardware. The execution of the DMAG may be scheduled and/or forced on a regular basis. By forcing a scheduled execution of the DMAG, the DMAG may contact a centralized management system that may issue one or more management commands on the platform. The management commands may include updates, patches, and/or other reconfigurations. For example, the management commands may include updates, patches, and other reconfigurations if the system stops working. For example, including updates, patches, and other reconfigurations may give possibilities in case there is a problem on the main OS (e.g., given that the recovery agent may have secure access to a full communication stack and/or network interface). The implementations may introduce communication overhead and the implementations may not ensure the system is kept updated. For example, the implementations may introduce DMAG to DMS regular communication and the implementation may not ensure the system is kept updated.

It may be a challenge to keep one or more WTRUs robust against SW vulnerabilities. For example, it may be a challenge to keep one or more WTRUs robust against the latest known SW vulnerabilities. It may be a challenge to protect networked devices against zero-day vulnerabilities. Zero-day vulnerabilities may include exploits that may be newly released and/or may be previously unknown. To keep one or more WTRUs (e.g., sensitive WTRUs) secure, WTRUs may be configured and/or WTRUs may be kept up to date with respect to SW vulnerabilities. Configuring WTRUs and/or keeping WTRUs up to date with respect to SW vulnerabilities may be a challenge. For example, configuring WTRUs and/or keeping WTRUs up to date with respect to SW vulnerabilities may be a challenge because an IoT infrastructure (e.g., a large IoT infrastructure) may include one or more devices running on one or more platforms and/or with one or more SW basis. Features may be provided to ensure that one or more WTRUs may be upgraded with respect to the latest known SW vulnerabilities. Features may be provided to ensure that one or more WTRUs may keep the communication overhead for the guarantees at a minimum. Ensuring that one or more WTRUs may be upgraded with respect to the latest known SW vulnerabilities and/or keeping the communication overhead for the guarantees at a minimum may make keeping one or more WTRUs robust against SW vulnerabilities with low overall impacts. For example, ensuring that one or more WTRUs may be upgraded with respect to the latest known SW vulnerabilities and/or the communication overhead for the guarantees may be kept at a minimum may make keeping one or more WTRUs robust against SW vulnerabilities efficient for battery driven and/or resource constrained WTRUs.

A secure execution environment on a WTRU may receive (e.g., may regularly receive) SW vulnerability reports, messages, etc. The reception periods may be approximate or precise. The reception periods may be system dependent. A secure execution environment on the WTRU may receive (e.g., regularly receive) SW vulnerability reports in the form of SW Vulnerability Tickets (SVTs). For example, a secure execution environment on the WTRU may regularly receive SW vulnerability reports in the form of SVTs from a central management system. The SVTs may comprise information regarding software update information (e.g., software patches, security patches, software configuration updates, software vulnerability signatures, such as critical software patches, critical security patches, critical software configuration updates, critical software vulnerability signatures, etc.). For example, the SVTs may comprise information about where to fetch a software patch (e.g., a critical SW patch). The SVTs may comprise information about whether the patch is small, comprises a software patch (e.g., a critical SW patch), and/or vulnerability signatures. The SVT may be issued by a trusted central Device Management System (DMS).

The SVT may have one or more of the following characteristics. The SVT may comprise a time stamp and/or a sequence number. The SVT may comprise one or more signatures of one or more vulnerabilities. For example, the SVT may comprise one or more new vulnerabilities that the unit may desire to scan on the device, a SW patch, and/or a configuration change to be applied. The SW patch to be applied may be a critical SW patch and/or the configuration change may be a critical configuration change. The SVT may comprise a resource address defining where to fetch a patch and/or where to fetch a configuration update. If there are no updates, the SVT may indicate that updates may not need to be made on the system. The updates may include security updates, such as security critical updates. An SVT with an empty body may provide an indication that updates may not need to be made on the system. The SVT may be digitally signed. For example, the SVT may be signed using a public key algorithm and/or a private key (e.g., a key of the management system).

The SVTs may be distributed to the WTRU in one or more ways. For example, the SVTs may be distributed to the WTRU by broadcast and/or unicast. The WTRU may fetch (e.g., regularity fetch) the SVTs. For example, the WTRU may regularly fetch the SVTs from a predefined server in the system.

On the WTRU, a Security Agent (SA) may be responsible for checking and/or applying security updates. The security updates may be critical updates. The SA may be the entity that interprets and/or receives SVTs from the DMS. The SA may run in a Secure Execution Environment (SEE). For example, the SA may run in an SEE on a WTRU platform. The platform may be an IoT platform. The SEE may not be dependent on the main OS running on the system. For example, a SW vulnerability (e.g., a critical SW vulnerability) in the main OS may not destroy the security provided by the SA and/or SEE. The SEE may be provided in one or more ways. The SEE may be provided as a separate virtual machine. The virtual machine may be on a virtualized platform. The SEE may be provided as a hardware based secure execution environment (e.g., ARM TrustZone (TZ) or Intel SGX). The SEE may be provided as a separate boot partition that may run at system reset/reboot.

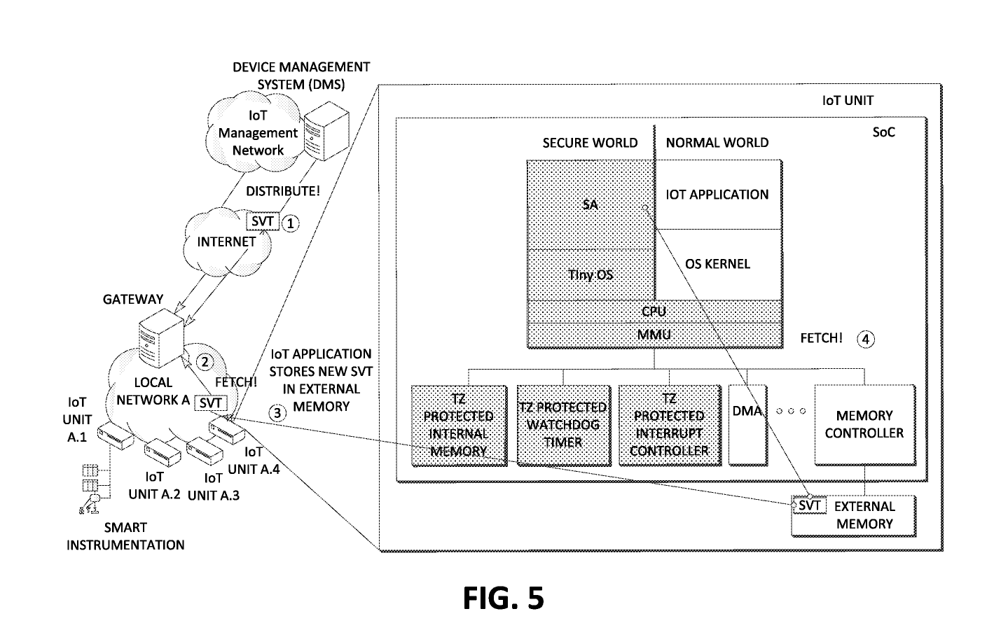

The DMS may distribute the SVTs to one or more WTRUs in the system. For example, the DMS may distribute the SVTs to one or more WTRUs in the system on time intervals (e.g., regular time intervals). The SVT may be placed in a pre-defined non-volatile memory area on the WTRU, e.g., once the WTRU receives the SVT. For example, the SVT may be placed in a pre-defined non-volatile memory area on the WTRU such that the SVT may be read by the SA running in the SEE. By placing the SVT in a pre-defined non-volatile memory area on the unit such that the SVT may be read by the SA running in the SEE, the device may not be dependent on the SA collecting the SVTs. Collecting the SVTs may be done by a SA proxy function running on another part of the system. The other part of the system may be a non-secure part of the system. FIG. 5 illustrates an example SVT distribution, reception, storage, etc.

The SA in the SEE may get execution rights. For example, the SA in the SEE may get execution rights according to a predefined regularity, periodicity, period, interval, etc. A watchdog enforcement function may ensure that SA in the SEE gets execution rights. For example, a watchdog enforcement function on a system on a chip (SoC) may ensure that the SA in the SEE gets execution rights.

The WTRU may perform one or more of the following actions. For example, the WTRU may perform one or more of the following actions to provide security protection for the WTRU. The WTRU may receive one or more SVTs. For example, the non-secure portion of the WTRU may receive the one or more SVTs and/or may store the one or more SVTs in a memory. The non-secure portion of the WTRU may receive the one or more SVTs and/or may store the one or more SVTs in a memory associated with the non-secure portion of the WTRU. The SA may receive the one or more SVTs and/or may store the one or more SVTs in a memory, etc. The SA may check the one or more SVTs in memory. For example, the SA may check the one or more SVTs in memory to determine a latest SVT in memory. Checking SVT(s) in memory may be done at a time that the WTRU has execution rights. The SA may check the one or more SVTs in memory periodically, upon being granted execution rights, according to a routine, etc. When checking the one or more SVTs in memory, the SA may identify the latest SVT using one or more of a sequence number of the one or more SVTs, a time indication associated with the one or more SVTs, etc., e.g., to ensure the one or more SVTs are fresh. For example, the SA may identify the latest SVT using one or more of a sequence number of the one or more SVTs, a time indication associated with the one or more SVTs, etc., to ensure that the one or more SVTs have been received by the WTRU within a predefined threshold time period, that the one or more SVTs have been received within a predefined sequence, etc. The SA may check the latest SVT (e.g., check for and/or read instructions in the latest SVT) and/or the SA may update the WTRU system according the instructions in the latest SVT.

If the SA fails to find a fresh SVT in the system, the SA may perform one or more of the following. If the SA fails to find a fresh SVT in the system and/or if the SA has network access, the SA may attempt to connect to a secure external service. For example, the SA may attempt to connect to a secure external service to retrieve a fresh SVT. If the SA fails to find a fresh SVT in the system and/or if the SA does not have network access, the SA may request the OS (e.g., the main OS) to fetch the latest SVT. The latest SVT may be the latest security information. If the SA fails to fetch the latest SVT within a predefined time, the WTRU (e.g., based on an action from the SA) may bring the WTRU back to a safe state. The WTRU may bring the WTRU back to a safe state, based on an action from the SA. For example, the WTRU may execute a recovery (e.g., a security emergency recovery) to bring the WTRU back into a safe state.

Features for ensuring that one or more WTRUs receives information (e.g., SVTs) about security updates may be provided herein. For example, features for ensuring that a large set of WTRUs regularly receives information (e.g., SVTs) about critical security updates may be provided herein. The features may be robust. For example, the features may be robust if the OS (e.g., the complete OS) of the normal execution environment of the device becomes compromised by a zero day vulnerability. A zero day vulnerability may not be prevented to affect the system. The system may be allowed (e.g., allowed in an efficient manner) to recover from a zero day vulnerability when a counter measure is available. For example, the system may be allowed (e.g., allowed in an efficient manner) to recover from a zero day vulnerability as soon as a counter measure is available. Zero day vulnerabilities may be common in real time and non-real time WTRU (e.g., IoT) operating systems.

An SA executing in an execution environment may provide robustness and/or may be independent of the SW in the system. For example, an SA executing in a secure execution environment may provide robustness and/or may be independent of the SW in the open part of the system. Enforcing execution of the SA through a watchdog mechanism and/or basic memory protection (e.g., Memory Management Unit (MMU) and/or a Memory Protection Unit (MPU)) may be hardware security requirements on the platforms. The features may be implemented on one or more WTRU (e.g., IoT) platforms. For example, the features may be implemented on resource constraint platforms and/or battery driven platforms.

Systems, methods, and instrumentalities may be agnostic with respect to how the SVTs may be distributed in the system. The SA may not need to have network connectivity to collect the SVTs under normal operation. A security back-up may be executed. For example, a security back-up may be executed when the SA determines that the WTRU is no longer receiving SVTs. If the WTRU is no longer receiving SVTs, the SA may perform a system recovery with network access to take place. There may be minimal system performance impact with respect to system resource utilization. For example, there may be minimal system performance impact with respect to bandwidth, network interface, power consumption, memories, etc.

The features described herein may be used in different orders and/or combinations. One of more of the features may be omitted and/or added.

Security provisioning may include one or more of the following. Security provisioning may include SVT generation and/or distribution. Security provisioning may include SVT collection and/or processing. Security provisioning may include SA implementation. For example, security provisioning may include WTRU-level SA implementation.

The following notations may be used throughout the disclosure. A WTRU in the system may be denoted by WTRU unit and/or u. An SVT with index i may be denoted by sᵢ. A private key used by the DMS to sign SVTs may be denoted by Pr_{DMS}. The public key of the DMS may be denoted by Pu_{DMS}. A maximum time between two consecutive SA execution periods may be denoted by Tₘₐₓ. The current value of a secure watchdog timer in the system may be denoted by t_{w}.

A SW vulnerability update for WTRUs (such as IoT units) may be provided. For example, a SW vulnerability update for WTRUs (such as IoT units) may be provided where a central system (e.g., the DMS) may issue SW Vulnerability Tickets (SVTs). The central system may regularly issue SW Vulnerability Tickets (SVTs). The time interval between the issuing of the SVT may be a constant time value T. For example, the time interval between the issuing of the SVT may be T<Tₘₐₓ. The sequence of SVTs issued by the DMS may be denoted by s₀, s₁, . . . , Sₙ₋₁. The time that elapses between the issuing of two or more consecutive SVTs, s_{i-1 and s}ᵢ, may equal T. An SVT may comprise information to the WTRUs. For example, an SVT may comprise SW update information to the WTRUs.

The SVTs may comprise one or more of the following parameters. The SVTs may comprise a sequence number: i. The SVTs may comprise SW update data: D. The SVTs may comprise a digital signature, sig, which may be over the fields in the SVT (e.g., {i, D,}) and/or may be signed using the key Pr_{DMS}. sᵢ may be equal to {i, D, sig}).

The information field of the SVT may be the field D. For example, the core information field of the SVT may be the field D. Dependent on system preferences, field D may comprise one or more types of data. Field D may comprise one or more of the following types of parameters. Field D may comprise a vulnerability signature function. Field D may comprise a list of functions that may be used to identify potential vulnerabilities on the device. For example, field D may comprise a list of functions that may be used to identify potential vulnerabilities on the device without executing the actual program to be analysed, such as the main OS and/or WTRU (e.g., IoT) application system. For a signature function, information about the severity of the vulnerability may be provided to the WTRU. Field D may comprise a SW patch and/or a list of patches and may have information regarding the target system to which the patches may apply.

The system may comprise one or more WTRUs running on one or more platforms and/or with one or more SW basis. The SVTs may be general. SVTs may comprise software update information (e.g., SW patches) that may apply to a subset of the WTRUs in the system.

Information about the importance of the software update information (e.g., the patch) may be provided to a WTRU. For example, information about when the patch should be applied may be provided to a WTRU. Information about the latest day, date, and/or time in which the patch should be applied may be provided to a WTRU. Field D may comprise a URL or list of URLs that may be used to retrieve one or more vulnerability signature functions and/or one or more SW patches. One or more severity grades may be indicated for the one or more URLs. The WTRU may use the severity grade to determine whether to apply the function and/or patch and/or what order to apply the function and/or patch. A URL may give information (e.g., an address) of where a WTRU can fetch one or more vulnerability signature functions and/or one or more SW patches. Field D may comprise a string indicating that no SW vulnerability information (e.g., no new SW vulnerability information) may be available.

The signature and/or patch information may be generated. The signature and/or patch information may be automatically generated and/or semi-automatically generated. For example, the signature and/or patch information may be generated automatically and/or semi-automatically at the DMS.

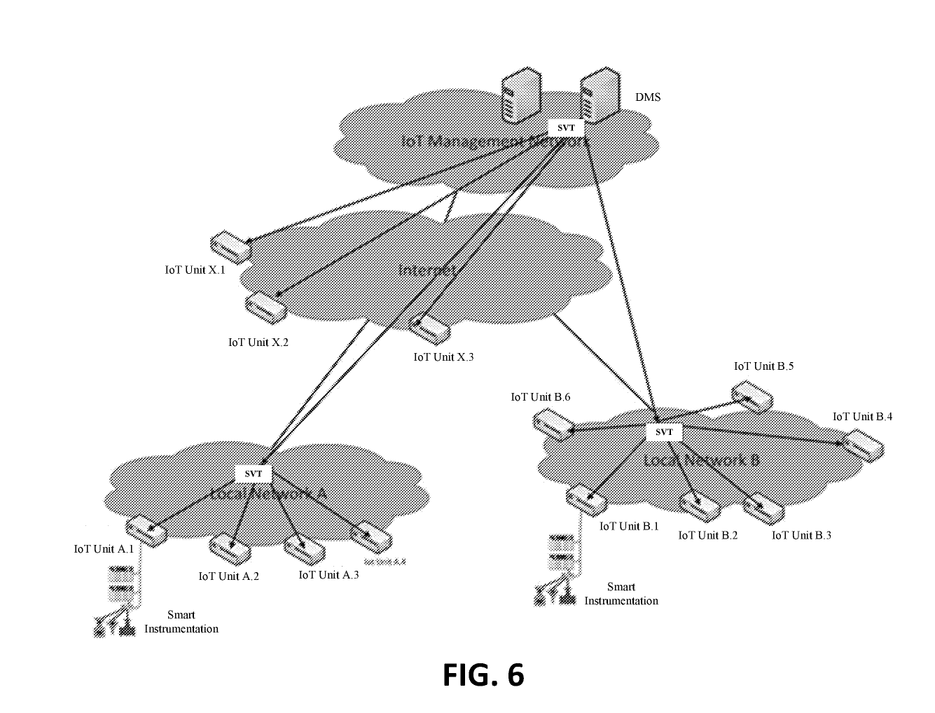

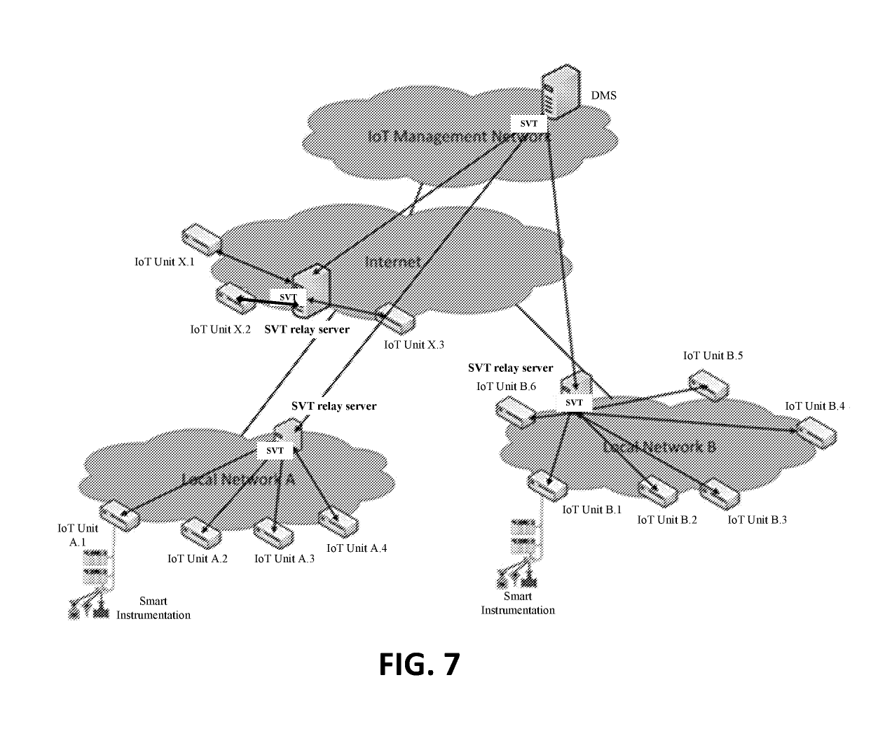

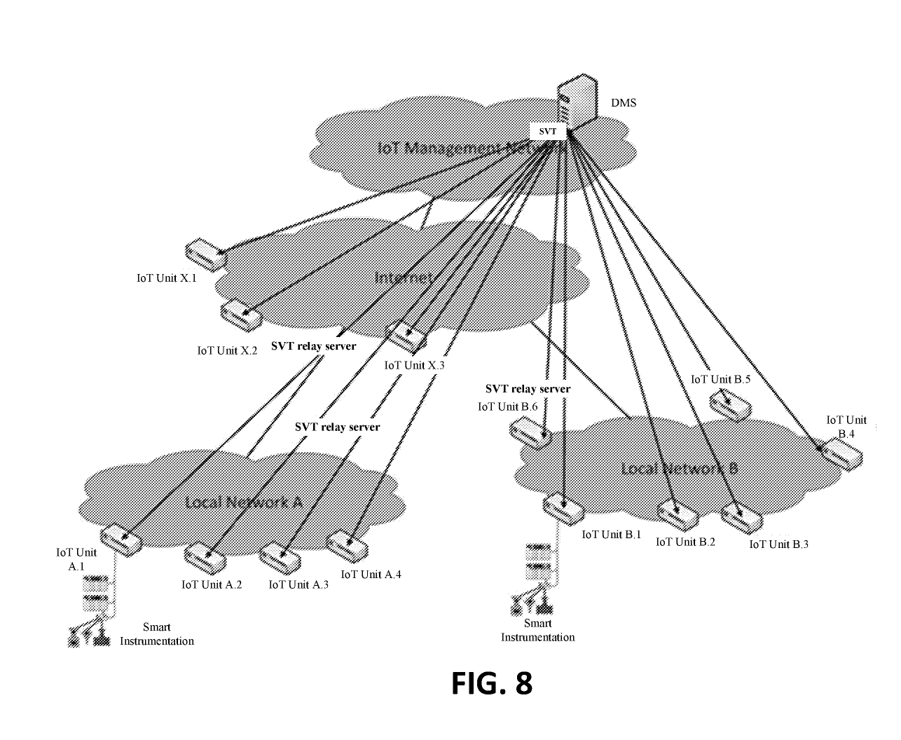

Implementations may be agnostic with respect to how the SVTs may be distributed to the WTRUs in the system. The SVTs may be distributed to the WTRUs based on one or more implementations. For example, the SVTs may be distributed to the WTRUs based on one or more implementations shown in FIGS. 6-8. The SVTs may be sent by multicast. For example, the SVTs may be regularly sent by multicast. The SVTs may be sent to the WTRU (e.g., IoT) network domains where they may be collected by the WTRUs. For example, the SVTs may be sent to the WTRU (e.g., IoT) network domains by the DMS. The SVTs may be sent to gateways and/or relay servers in network domains from where the SVTs may be fetched by the WTRUs. For example, the SVTs may be sent to gateways and/or relay servers in one or more WTRU (e.g., IoT) network domains from where the SVTs may be fetched by the WTRUs. The WTRUs may connect at pre-defined time intervals to the DMS systems and/or may download the SVT (e.g., the latest SVT). For example, the WTRUs may download the latest SVT.

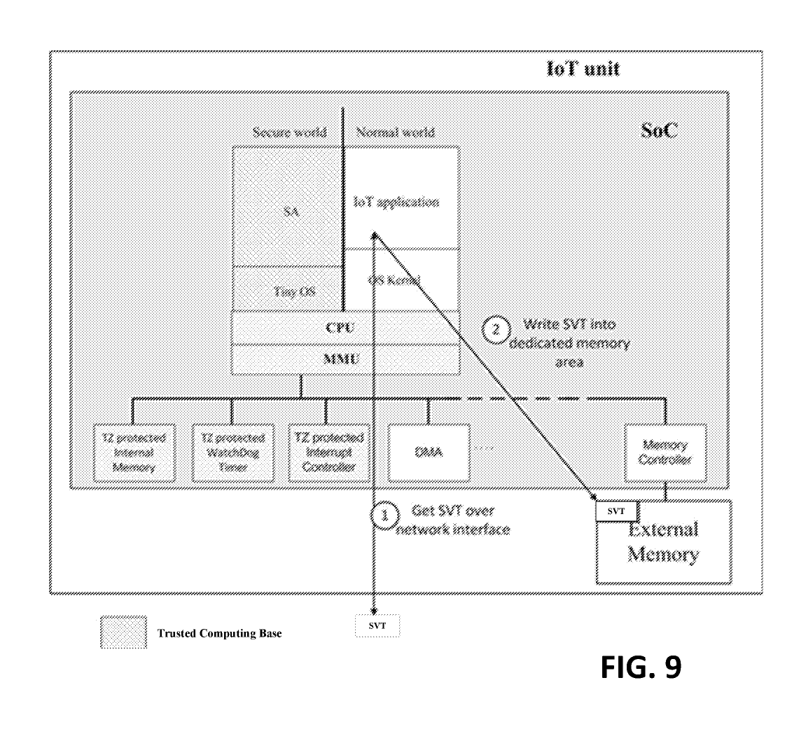

A WTRU may have an application (e.g., an IoT application) that may be responsible for collecting one or more SVTs and/or SVT information at the WTRU (e.g., IoT unit). The application may place the SVT and/or the SVT information in a dedicated memory area on the non-volatile storage of the device. For example, the application may place the SVT and/or the SVT information in a dedicated memory area on the non-volatile storage of the device from where the SVT and/or SVT information may be fetched by the SA. FIG. 9 shows an example where the application may place the SVT and/or the SVT information in a dedicated memory area on the non-volatile storage of the device from where the SVT information may be fetched by the SA. For example, the application may place the SVT and/or SVT information in a dedicated memory area on the non-volatile storage of the device from where it can be fetched by the SA once the application has received a predefined SVT, as described herein.

SA SVT collection and processing may be provided.

SA SVT collection and/or processing at the WTRU may be described. The SA running on the SEE (e.g., on the WTRU) may have been provided with one or more of the following pre-configurations. The SA running on the SEE on the WTRU may have been provided with access to the trusted public key of the DMS (e.g., Pu_{DMS}). The public key of the DMS may allow the SA to distinguish valid SVTs from non-valid SVTs. For example, the public key of the DMS may allow the SA to distinguish SVTs that may have been issued by the authorized DMS of the system.

The SA running on the SEE on the WTRU may have been provided with direct access to a non-volatile memory area on the system. For example, the SA running on the SEE on the WTRU may have been provided with direct access to an area on the system where the open part of the system may store SVTs, such as new SVTs. The SA running on the SEE on the WTRU may have been provided with the SA running on an OS (e.g., a tiny OS). For example, the SA running on the SEE on the WTRU may have been provided with the SA running on an OS, including a full network stack that may allow the SA to have full control over network resources on the WTRU and/or to make connections. The connections may be secure external network connections. The SA running on the SEE on the WTRU may have been provided with access (e.g., unique access) to a hardware watchdog timer on the system. The hardware watchdog timer may be denoted as t_{w}.

The SA may get execution rights. For example, the SA may get execution rights with regularity. The maximum allowed period between two SA executions (e.g., two consecutive SA executions) may be denoted by Tₘₐₓ. The WTRU (e.g., IoT unit) hardware may ensure the SA in the SEE gets execution rights. For example, the WTRU (e.g., IoT unit) hardware may ensure the SA in the SEE gets execution rights with regularity. The SA in the SEE getting execution rights may be guaranteed by a watchdog enforcement function. For example, the SA in the SEE getting execution rights may be guaranteed by a watchdog enforcement function on a system on a chip (SoC).

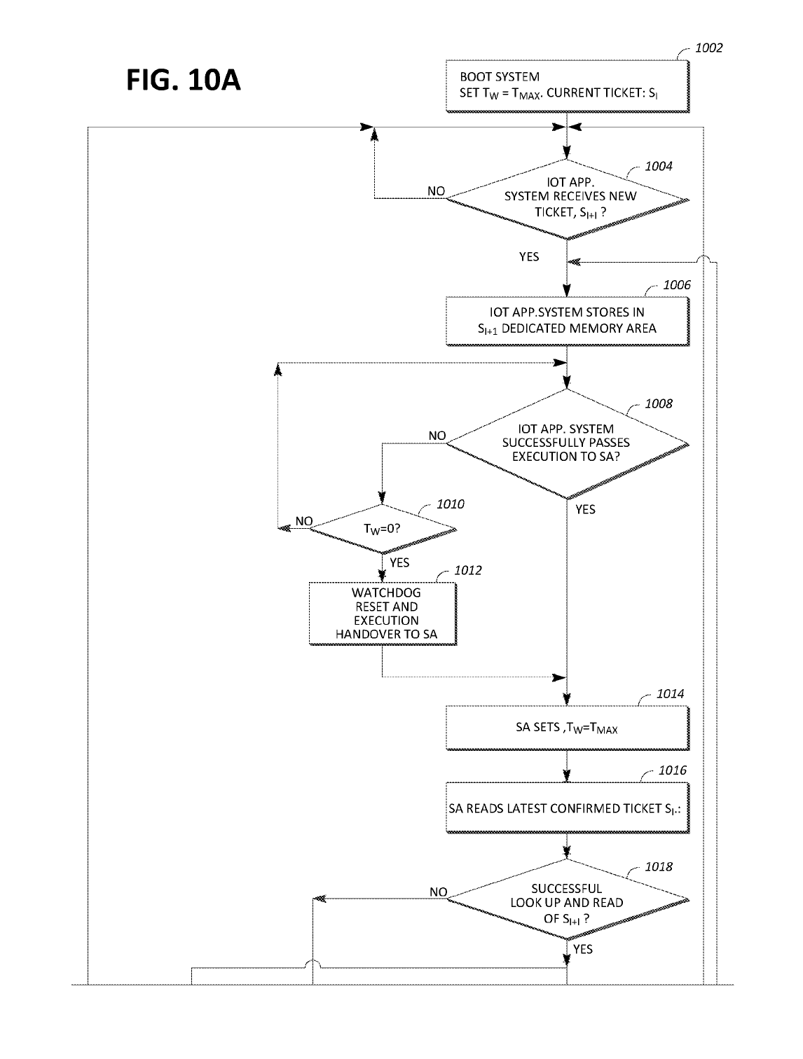

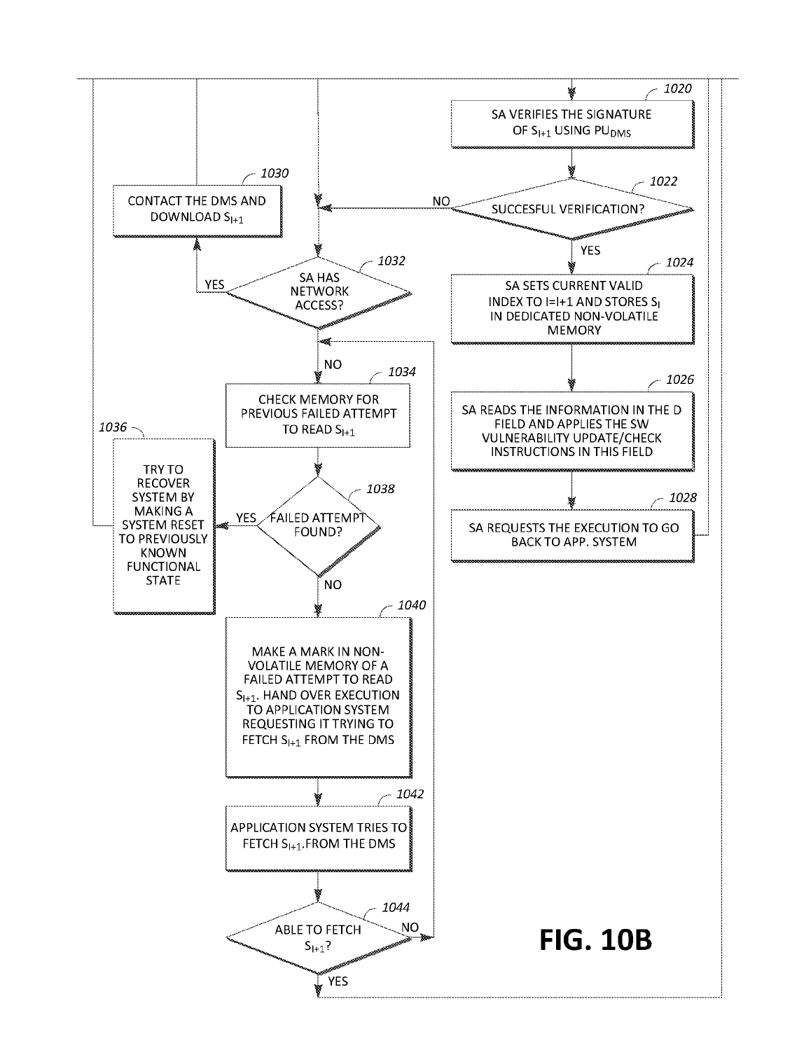

FIGS. 10A, 10B show an example where one or more of the following may apply. At 1002, the WTRU (e.g., the IoT device) may be booted. At boot time, t_{w} may be set to Tₘₐₓ. At boot time, the boot code may ensure that the latest valid SVT is stored in the dedicated non-volatile memory area of the device. An SVT may be denoted by sᵢ. For example, the current valid SVT index may be set to i. One or more of the delivery options specified herein may be used. At 1004, it may be determined whether the WTRU has received an SVT (e.g., a new SVT, such as sᵢ₊₁). For example, an application running on the WTRU may determine whether the WTRU has received an SVT (e.g., a new SVT, such as sᵢ₊₁). If the WTRU has not received an SVT (e.g., a new SVT), return to 1004 and determine if the WTRU has received an SVT. If the WTRU (e.g., an application running on the WTRU) receives an SVT (e.g., a new SVT), move to 1006.

At 1006, the WTRU (e.g., an application running on the WTRU) and/or a management application in the WTRU domain may store the SVT (e.g., the new SVT). The SVT may be stored in the dedicated non-volatile memory area. For example, the WTRU (e.g., an application running on the WTRU) and/or a management application in the WTRU domain may store the SVT on the application system of the WTRU. The application system of the WTRU may be the main operating system of the WTRU. At 1008, it may be determined whether the application system may pass over execution (e.g., execution rights) to the SEE and/or the SA. For example, it may be determined whether the application system may pass over execution rights to the SEE and/or the SA at a predefined time before a watchdog reset applies. For example, the application system may pass over execution to the SEE and the SA if the application system does not comprise a major vulnerability. If it is determined that the application system is to pass over execution to the SEE and/or SA, move to 1014.

If it is determined that the application system is not to pass over execution to the SEE and/or SA, move to 1010. At 1010, if t_{w}=0, a watchdog reset may apply and/or the system may issue a watchdog reset at 1012, and move to 1014. The watchdog reset may force the system to hand over the execution to the SEE and/or the SA. If t_{w} is not equal to 0, move to 1008.

At 1014, the SA may execute and/or the SA may reset the watchdog timer, t_{w}=Tₘₐₓ. At 1016, the SA may execute and/or the SA may read an SVT. For example, the SA may execute and/or the SA may read the latest SVT (e.g., the latest valid confirmed SVT, sᵢ). The SA may execute and/or the SA may read an SVT from non-volatile memory. The SA may execute and/or the SA may look for an SVT in the non-volatile memory. The SVT may be a new SVT. The SVT may have an index i+1 (e.g., sᵢ₊₁).

At 1018, it may be determined whether sᵢ₊₁is found in the system. If sᵢ₊₁ is found in the system, move to 1020, and the following may apply, otherwise, move to 1032. If sᵢ₊₁ is found in the WTRU, the SA may, at 1020, use the key Pu_{DMS} to verify that sᵢ₊₁ is a valid SVT. If the verification fails at 1022, move to 1032.

If sᵢ₊₁ is found (e.g., found in the WTRU), at 1022, the SA, at 1024, may update the current valid SVT index to i=i+1 and/or the SA may store sᵢ₊₁. The SA may store sᵢ₊₁ as a new sᵢ. SA may store sᵢ₊₁ in a memory associated with the WTRU. For example, SA may store sᵢ₊₁ in the dedicated non-volatile memory area. At 1026, the information in the D field may be read and/or the SW vulnerability update/check instructions may be applied in the D field.

One or more of the following actions may result in accordance with the ticket contents. The SA may read the information in the D field. The SA may apply the SW vulnerability update and/or check instructions in the D field. If the SVT comprises vulnerability signature functions, the vulnerability signature functions may be applied on the system. The SA may search for the vulnerabilities on the system. If one or more of the vulnerabilities are found, the SA may request a reset. For example, dependent on the severity of the vulnerabilities found, the SA may request a restart to a latest known secure SW state. Restarting to a latest known secure SW state may imply a reflash (e.g., complete reflash) of the application system part. The application system part may be the main operating system part. If not critical, the SA may set a time for reset, inform the application system of the time for the WTRU reset, and/or set the watch dog timer (e.g., t_{w}) accordingly. At 1026, the SA may read the information in the D field, and/or the SA may apply the SW vulnerability update and/or check instructions in the D field. If the SVT comprises a list of SW patches, the patches may be checked. If the patches apply to the current application system running on the WTRU, the SA may install the relevant patches in the list. The SA may install the relevant patches in the list after discovery or the install may be performed at a scheduled update. For example, the SA may install the relevant patches in the list immediately after discovery or the install may be performed at a scheduled update.

If the SVT comprises a list of one or more URLs to vulnerability signatures, the SA may download the signatures and/or apply the signatures. The SA may download the signatures and/or apply the signatures if the SA has direct network access. If the SA does not have network access, the SA may hand over (e.g., may first hand over) the execution to the application system and/or may request the application system to download the signatures and/or return execution to the SA on the SEE. The SA may hand over the execution to the application system with the URL. At 1026, the SA may read the information in the D field, and/or the SA may apply the SW vulnerability update/check instructions in this field. If the SVT comprises a list of one or more URLs to SW patches, the SA may download relevant SW patches for the WTRU application system and may apply the SW patches. The SA may download the SW patches for the WTRU application system and/or may apply the SW patches if the SA has network (e.g., direct network) access. If the SA does not have network access, the SA may hand over (e.g., first hand over) the execution to the application system and/or may request the application system to download the signatures and/or return execution to the SA on the SEE. If sᵢ₊₁ is found in the WTRU, the SA may read the information in the D field, and/or the SA may apply the SW vulnerability update and/or check instructions in the field. If the field D indicates that no WTRU update (e.g., no critical WTRU update) applies, the SA may not take action.

At 1028, execution may go back to the application system. For example, the SA may request that execution go back to the application system after a WTRU reboot, depending on the nature of the updates that may be applied. The SA may request that hardware (e.g., CPU) of the WTRU switch the execution back to the application system. Move to 1004.

At 1032, it may be determined if SA has network access. If the SA has network access, the SA may, at 1030, contact DMS of the system and/or request a download of the latest valid SVT (e.g., sᵢ₊₁). The SA may write the download of the latest valid SVT into non-volatile memory. Move to 1020.

If, at 1032, the SA does not have network access and/or a failed sᵢ₊₁ access attempt has occurred, the SA may, at 1034, check in memory (e.g., non-volatile memory). The SA may check in memory to determine whether a failed sᵢ₊₁ access attempt may be found. If, at 1038, a failed sᵢ₊₁ access attempt is found, the SA may, at 1036, force a WTRU reset and may move to 1004. For example, the SA may force a full WTRU reset to a previous known secure state. If no failed sᵢ₊₁ access attempt is detected, move to 1040. At 1040, make a mark in non-volatile memory of a failed sᵢ₊₁ access attempt and/or hand over the execution to the application system with an indication of requesting the missing sᵢ₊₁. The application system may, at 1042, attempt to fetch (e.g., download) the missing SVT sᵢ₊₁ from the DMS. If, at 1044, the application system's attempt to download the missing SVT sᵢ₊₁ from the DMS fails, move to 1034. The application system may not be able to repeat the download attempt indefinitely. If, at 1038, the application system's attempt to download the missing SVT sᵢ₊₁ directly from the DMS fails, move to 1036. The application system may give up and/or may perform a full WTRU reset. The application system may give up at a predetermined time. If, at 1044, the application system's attempt to download the missing SVT sᵢ₊₁ directly from the DMS is successful, move to 1006. The application system may hand over execution back to the SEE.

Details of different SA implementations may be provided. The implementations may be used as described or combinations of various features of the different SA implementations may be used.

A virtualization based implementation may be provided.

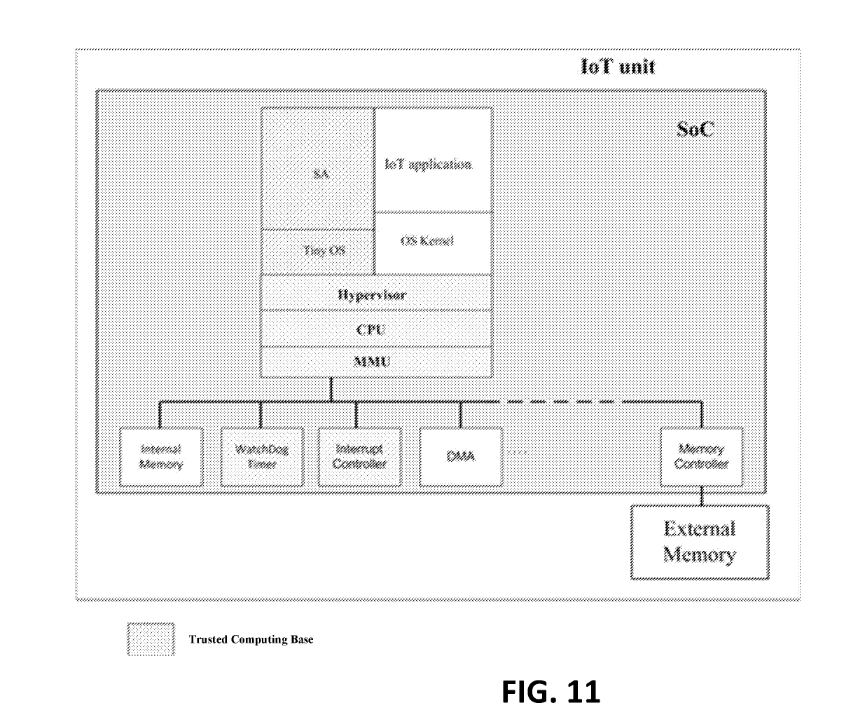

The SA may be running in a virtual machine (e.g., its own virtual machine). For example, the SA may be running in a virtual machine isolated from the main WTRU application system in a different virtual machine (e.g., different from the WTRU application system). Isolation between virtual machines may be provided with CPU virtualization software (e.g., MMU), interrupt controller functions, and/or I/O MMU functions. The WTRU may allow the virtual machine running the SA, the hypervisor, and/or the optional tiny OS hosting the SA to have control (e.g., full control) over a hardware watchdog. For example, the WTRU may allow the virtual machine running the SA, the hypervisor, and/or the optional tiny OS hosting the SA to have control over a hardware watchdog such that a compromised WTRU may not destroy security of the SA. The trusted hypervisor may have control (e.g., full control) over the interrupt controller configurations. For example, the trusted hypervisor may have control (e.g., full control) over the interrupt controller configurations such that a compromised WTRU may not be able to interrupt the SA while running security tasks (e.g., security critical tasks. A secure boot process may ensure that the trusted execution part of the WTRU may be booted into a trusted state. For example, SA and/or all other code running in the secure part of the WTRU may be integrity checked. Secure boot may be a standard feature in embedded systems. FIG. 11 shows an example for a single CPU SoC. The implementation feature may be extended to work in a multicore platform setting.

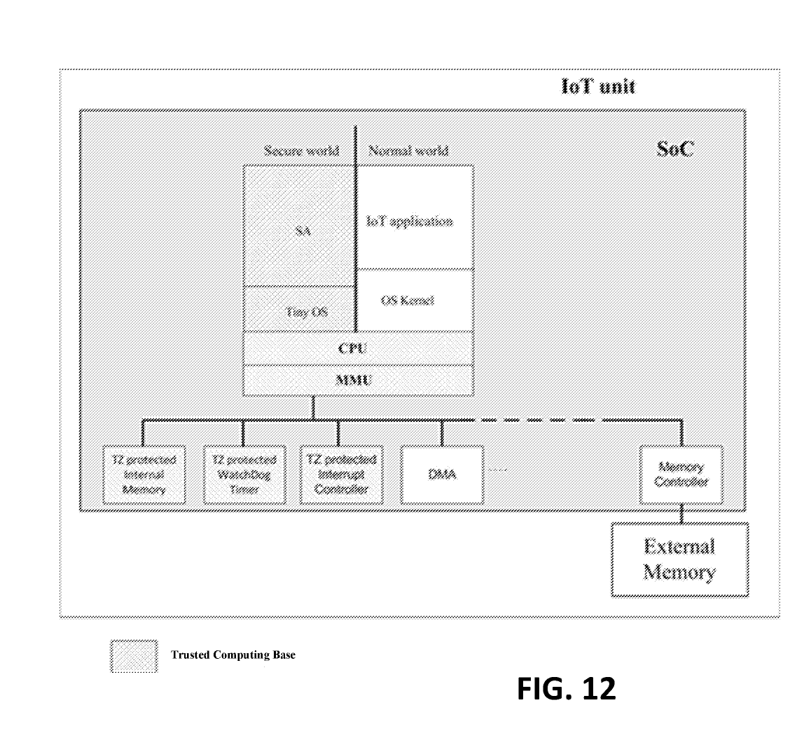

A secure execution mode based implementation may be provided. The SA may be implemented as a trusted application in secure mode. For example, the SA may be implemented as a trusted application in secure mode according to an ARM TZ concept and/or as a secure process in a SGX enclave (e.g., according to an Intel secure execution model). The hardware may allow the SA to have control (e.g., full control) over a hardware watchdog. For example, the hardware may allow the SA to have control (e.g., full control) over a hardware watchdog, such that a compromised WTRU may not destroy security. The hardware may allow the SA to have control (e.g., full control) over a hardware watchdog, such that a compromised WTRU may not destroy security, similar to the virtualization based implementation. A secure booting process may ensure that the trusted execution part of the WTRU is booted (e.g., always booted) into a trusted state. The SA and other code running in the secure part of the WTRU may be integrity checked. The SA in the TZ case may run on an OS (e.g., a tiny OS). The SA in the TZ case running on an OS (e.g., a tiny OS) may not be the case in the SGX option, and/or the SA may run as a process in a protected enclave. The process may be a separate process. The CPU hardware may ensure secure transitions between the secure and non-secure execution on the platform. For example, the CPU hardware may ensure secure transitions between the secure and non-secure execution on the platform, including making sure memory (e.g., sensitive memory) and/or CPU control buffers are cleared before switching the execution modes. FIG. 12 shows a TZ based implementation for a single CPU SoC. The implementation feature may be extended to work in a multicore platform setting and/or the SGX setting.

A SW dual-boot based implementation may be provided. The SA may not be provided as an application running in a separate SEE. For example, the SA may not be provided as an application running in a separate SEE in parallel with the main WTRU application system. The SA may be provided as a separate single execution mode in a dual boot system. The dual-boot secure system may be implemented on an embedded system. The platform may be booted into two or more execution modes. An execution mode may include the main application running on the WTRU. Another execution mode may include the SA running on a tiny and/or secure OS. The execution modes may be implemented on one or more standardized SoCs. For example, the execution modes may be implemented on one or more standardized SoCs with a few hardware extensions.

The SoC may provide one or more of the following. The SoC may provide a secure boot process that may ensure that the intended SA may be booted on the WTRU when booted into secure mode. The SoC may provide a secure boot process that may ensure that only the intended SA and/or tiny OS may be booted on the WTRU when booted into secure mode. The SoC may provide a possibility to lock out some non-volatile memory regions from write access when booted into non-secure mode. For example, the SoC may provide a possibility to lock out some non-volatile memory regions from write access through MMU when booted into non-secure mode. The SoC may provide a possibility to lock out the complete WTRU from write access when booted into non-secure mode. For example, the SoC may provide a possibility to lock out the complete WTRU from write access to a watchdog when booted into non-secure mode.

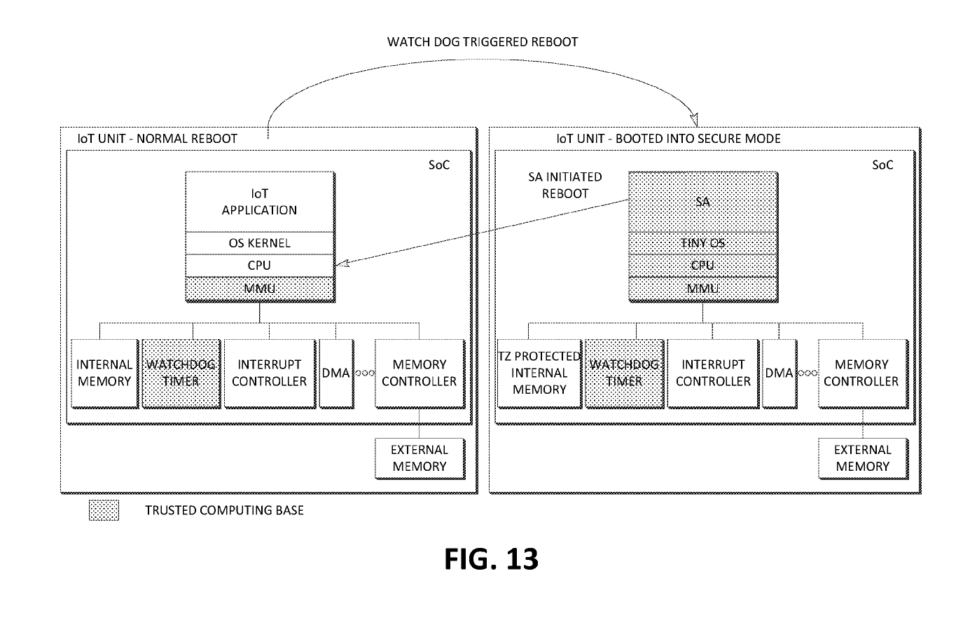

The functions may be realized with one or more hardware registers and/or additions to standard MMUs. For example, functions besides secure boot, which may be needed for security, may be realized with one or more hardware registers and/or additions to standard MMUs. The SA may need (e.g., infrequently need) execution rights. For example, the SA may need execution rights once per day and/or similar. FIG. 13 illustrates an example of a single CPU system. The implementation feature may be extended to work in a multicore platform setting.

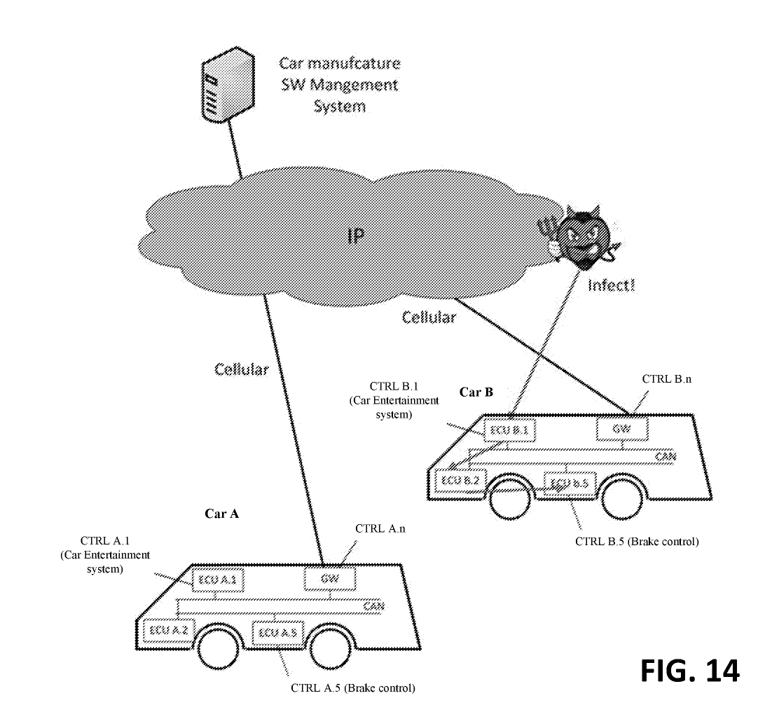

An automotive example is depicted in FIG. 14. In this example, a car manufacture may have one or more Electronic Controlling Units (ECUs) installed in the cars. An ECU may be used to control and/or monitor one or more kinds of functionalities. For example, ECUs may control engine, brakes, and/or other core car functions. ECUs may handle end-user services. For example, ECUs may handle a music system, navigation, etc. The cars may support online upgrade of ECUs in the system. For example, the cars may support online upgrade of ECUs in the system in order to allow cost efficient product enhancement. The car manufacturer may use one or more systems for end-user services. For example, the car manufacturer may use one or more systems for end-user services and core car functions in order to protect the system from attacks. The one or more systems may not have direct network connectivity. A car central SW management system may issue SVTs to one or more ECUs in cars. For example, a car central SW management system may issue one or more SVTs on a regular basis, such as once per day, to one or more ECUs in one or more of the cars.

An attacker may find network vulnerability in the entertainment system of the car. The vulnerability may allow the attacker to perform one or more of the following. The vulnerability may allow the attacker to fool the entertainment system to install a Trojan into the entertainment system. For example, when the entertainment system (e.g., ECU no. 1 in the system) connects to a third party music server and/or when the server connects to a popular third party online streaming service, the attacker may be able to fool the entertainment system to install a Trojan into the entertainment system. The installed Trojan may prevent the entertainment SW management system from working correctly. For example, the installed Trojan may prevent one or more attempts to download fresh SVTs from the central management system and/or may prevent execution of hand-over to a secure execution environment in the system. The Trojan may be able to use the internal network and/or to connect to a power controlling ECU in the system. For example, the Trojan may be able to use the internal network and/or to connect to a power controlling ECU in the system once the Trojan is installed on ECU no. 1. The power controlling ECU may be ECU no. 2. The attacking Trojan may be able to issue internal car network (e.g., CAN) attacks against ECU no 2. The internal car network (e.g., CAN) attacks against ECU no 2. may result in a denial-of-service attack of the brake control of the car. For example, the internal car network (e.g., CAN) attacks against ECU no 2. may result in a denial-of-service attack of the brake control of the car due to a weakness in the design and implementation of ECU no. 2 in the system. The brake control of the car may be ECU no. 5. A denial-of-service attack of the brake control of the car may result in the brakes not working correctly, which may be a threat to human life.

After a first accident, the car manufacture may become aware of the attack and may manage to find a signature function that may detect if a particular car may be infected. The car manufacture may issue a signature SVT (e.g., a new signature SVT) that may allow the SA running on the entertainment ECU to detect if the ECU is infected by the vulnerability. For example, the car manufacture may issue a signature SVT (e.g., a new signature SVT) that may allow the SA running on the entertainment ECU to detect if the ECU is infected by the infected car B in FIG. 14.

The SA running on the entertainment ECU may detect if an ECU is infected by the vulnerability. The car manufacture may issue an SVT (e.g., a new SVT) which may comprise a function for the detection of the Trojan. The function may be a signature function. The SVT may be signed with a public key. For example, the SVT may be signed with a public key of the car manufacture SW management system according to the features described herein. The ECU B.1 may be running an SA in a virtual machine (e.g., a separate virtual machine). A management application in the main system may download a fresh SVT periodically (e.g., once a day) from the central SW management system. For example, a management application in the main system may download a fresh SVT once a day from the central SW management system. The Trojan that infected ECU B.1 may prevent the fresh download from happening. At midnight, a secure watchdog reset may occur as the secure virtual machine may not have execution rights for more than a time period (e.g., more than 1 hour, 24 hours, etc.). The SA running on the secure virtual machine on the system may get execution rights and look for a fresh SVT in the system. The SA running on the secure virtual machine on the system may get execution rights due to the watchdog reset. As no such SVT is found, the SA may utilize direct network connectivity capabilities and may download a fresh SVT directly from the car manufacture SW management system. The SA may run the signature (e.g., new signature) function to analyse the open part of the system. The open part of the system may be the entertainment system. The SA may run the signature (e.g., new signature) function once the SVT has been downloaded. The signature function may show that the entertainment system may be infected. The SVT may indicate an attack (e.g., a severe attack). The SVT indicating an attack may make the SA issue a system wide alert in the car and/or may prevent driving until the SW system of the car has been updated.

The example of FIG. 14 shows how the features described herein may make security systems (e.g., critical security systems) like automotive and/or other WTRU system more robust against zero day attacks. Other WTRU systems may include plant control systems, physical access systems, medical device systems, traffic control systems, etc.

A high burden may be placed on the WTRUs. For example, a high burden may be placed on the WTRUs as the WTRUs may need to download (e.g., regularly download) SVTs (e.g., new SVTs). The WTRUs may need to download (e.g., regularly download) SVTs (e.g., new SVTs), even if the system does not require an update. As the WTRUs may have network connectivity and the SVTs may not comprise update information, regularly downloading new SVTs, even if the system does not require an update, may be justified in security systems (e.g., critical security systems). In systems (e.g., less sensitive systems) the SVT download period may be prolonged, making a lessened performance impact.

In the case of missing SVTs, the system may be dependent on the WTRU application and/or SA being able to contact (e.g., directly contact) the DMS in the system and/or being able to download an SVT (e.g., a missing SVT). This may be considered to be a rare case.

FIG. 15A is a diagram of an example communications system 1500 in which one or more disclosed embodiments may be implemented. The communications system 1500 may be a multiple access system that provides content, such as voice, data, video, messaging, broadcast, etc., to multiple wireless users. The communications system 1500 may enable multiple wireless users to access such content through the sharing of system resources, including wireless bandwidth. For example, the communications systems 1500 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 15A, the communications system 1500 may include wireless transmit/receive units (WTRUs) 1502a, 1502b, 1502c, and/or 1502d (which generally or collectively may be referred to as WTRU 1502), a radio access network (RAN) 1503/1504/1505, a core network 1506/1507/1509, a public switched telephone network (PSTN) 1508, the Internet 1510, and other networks 1512, though it will be appreciated that the disclosed embodiments contemplate any number of WTRUs, base stations, networks, and/or network elements. Each of the WTRUs 1502a, 1502b, 1502c, 1502d may be any type of device configured to operate and/or communicate in a wireless environment. By way of example, the WTRUs 1502a, 1502b, 1502c, 1502d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 1500 may also include a base station 1514a and a base station 1514b. Each of the base stations 1514a, 1514b may be any type of device configured to wirelessly interface with at least one of the WTRUs 1502a, 1502b, 1502c, 1502d to facilitate access to one or more communication networks, such as the core network 1506/1507/1509, the Internet 1510, and/or the networks 1512. By way of example, the base stations 1514a, 1514b may be a base transceiver station (BTS), a Node-B, an eNode B, a Home Node B, a Home eNode B, a site controller, an access point (AP), a wireless router, and the like. While the base stations 1514a, 1514b are each depicted as a single element, it will be appreciated that the base stations 1514a, 1514b may include any number of interconnected base stations and/or network elements.

The base station 1514a may be part of the RAN 1503/1504/1505, which may also include other base stations and/or network elements (not shown), such as a base station controller (BSC), a radio network controller (RNC), relay nodes, etc. The base station 1514a and/or the base station 1514b may be configured to transmit and/or receive wireless signals within a particular geographic region, which may be referred to as a cell (not shown). The cell may further be divided into cell sectors. For example, the cell associated with the base station 1514a may be divided into three sectors. Thus, in one embodiment, the base station 1514a may include three transceivers, e.g., one for each sector of the cell. In another embodiment, the base station 1514a may employ multiple-input multiple output (MIMO) technology and, therefore, may utilize multiple transceivers for each sector of the cell.

The base stations 1514a, 1514b may communicate with one or more of the WTRUs 1502a, 1502b, 1502c, 1502d over an air interface 1515/1516/1517, which may be any suitable wireless communication link (e.g., radio frequency (RF), microwave, infrared (IR), ultraviolet (UV), visible light, etc.). The air interface 1515/1516/1517 may be established using any suitable radio access technology (RAT).

More specifically, as noted above, the communications system 1500 may be a multiple access system and may employ one or more channel access schemes, such as CDMA, TDMA, FDMA, OFDMA, SC-FDMA, and the like. For example, the base station 1514a in the RAN 1503/1504/1505 and the WTRUs 1502a, 1502b, 1502c may implement a radio technology such as Universal Mobile Telecommunications System (UMTS) Terrestrial Radio Access (UTRA), which may establish the air interface 1515/1516/1517 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 1514a and the WTRUs 1502a, 1502b, 1502c may implement a radio technology such as Evolved UMTS Terrestrial Radio Access (E-UTRA), which may establish the air interface 1515/1516/1517 using Long Term Evolution (LTE) and/or LTE-Advanced (LTE-A).

In other embodiments, the base station 1514a and the WTRUs 1502a, 1502b, 1502c may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 1514b in FIG. 15A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 1514b and the WTRUs 1502c, 1502d may implement a radio technology such as IEEE 802.11 to establish a wireless local area network (WLAN). In another embodiment, the base station 1514b and the WTRUs 1502c, 1502d may implement a radio technology such as IEEE 802.15 to establish a wireless personal area network (WPAN). In yet another embodiment, the base station 1514b and the WTRUs 1502c, 1502d may utilize a cellular-based RAT (e.g., WCDMA, CDMA2000, GSM, LTE, LTE-A, etc.) to establish a picocell or femtocell. As shown in FIG. 15A, the base station 1514b may have a direct connection to the Internet 1510. Thus, the base station 1514b may not be required to access the Internet 1510 via the core network 1506/1507/1509.

The RAN 1503/1504/1505 may be in communication with the core network 1506/1507/1509, which may be any type of network configured to provide voice, data, applications, and/or voice over internet protocol (VoIP) services to one or more of the WTRUs 1502a, 1502b, 1502c, 1502d. For example, the core network 1506/1507/1509 may provide call control, billing services, mobile location-based services, pre-paid calling, Internet connectivity, video distribution, etc., and/or perform high-level security functions, such as user authentication. Although not shown in FIG. 15A, it will be appreciated that the RAN 1503/1504/1505 and/or the core network 1506/1507/1509 may be in direct or indirect communication with other RANs that employ the same RAT as the RAN 1503/1504/1505 or a different RAT. For example, in addition to being connected to the RAN 1503/1504/1505, which may be utilizing an E-UTRA radio technology, the core network 1506/1507/1509 may also be in communication with another RAN (not shown) employing a GSM radio technology.

The core network 1506/1507/1509 may also serve as a gateway for the WTRUs 1502a, 1502b, 1502c, 1502d to access the PSTN 1508, the Internet 1510, and/or other networks 1512. The PSTN 1508 may include circuit-switched telephone networks that provide plain old telephone service (POTS). The Internet 1510 may include a global system of interconnected computer networks and devices that use common communication protocols, such as the transmission control protocol (TCP), user datagram protocol (UDP) and the internet protocol (IP) in the TCP/IP internet protocol suite. The networks 1512 may include wired or wireless communications networks owned and/or operated by other service providers. For example, the networks 1512 may include another core network connected to one or more RANs, which may employ the same RAT as the RAN 1503/1504/1505 or a different RAT.

Some or all of the WTRUs 1502a, 1502b, 1502c, 1502d in the communications system 1500 may include multi-mode capabilities, e.g., the WTRUs 1502a, 1502b, 1502c, 1502d may include multiple transceivers for communicating with different wireless networks over different wireless links. For example, the WTRU 1502c shown in FIG. 15A may be configured to communicate with the base station 1514a, which may employ a cellular-based radio technology, and with the base station 1514b, which may employ an IEEE 802 radio technology.

FIG. 15B is a system diagram of an example WTRU 1502. As shown in FIG. 15B, the WTRU 1502 may include a processor 1518, a transceiver 1520, a transmit/receive element 1522, a speaker/microphone 1524, a keypad 1526, a display/touchpad 1528, non-removable memory 1530, removable memory 1532, a power source 1534, a global positioning system (GPS) chipset 1536, and other peripherals 1538. It will be appreciated that the WTRU 1502 may include any sub-combination of the foregoing elements while remaining consistent with an embodiment. Also, embodiments contemplate that the base stations 1514a and 1514b, and/or the nodes that base stations 1514a and 1514b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 15B and described herein.

The processor 1518 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1518 may perform signal coding, data processing, power control, input/output processing, and/or any other functionality that enables the WTRU 1502 to operate in a wireless environment. The processor 1518 may be coupled to the transceiver 1520, which may be coupled to the transmit/receive element 1522. While FIG. 15B depicts the processor 1518 and the transceiver 1520 as separate components, it will be appreciated that the processor 1518 and the transceiver 1520 may be integrated together in an electronic package or chip.

The transmit/receive element 1522 may be configured to transmit signals to, or receive signals from, a base station (e.g., the base station 1514a) over the air interface 1515/1516/1517. For example, in one embodiment, the transmit/receive element 1522 may be an antenna configured to transmit and/or receive RF signals. In another embodiment, the transmit/receive element 1522 may be an emitter/detector configured to transmit and/or receive IR, UV, or visible light signals, for example. In yet another embodiment, the transmit/receive element 1522 may be configured to transmit and receive both RF and light signals. It will be appreciated that the transmit/receive element 1522 may be configured to transmit and/or receive any combination of wireless signals.

In addition, although the transmit/receive element 1522 is depicted in FIG. 15B as a single element, the WTRU 1502 may include any number of transmit/receive elements 1522. More specifically, the WTRU 1502 may employ MIMO technology. Thus, in one embodiment, the WTRU 1502 may include two or more transmit/receive elements 1522 (e.g., multiple antennas) for transmitting and receiving wireless signals over the air interface 1515/1516/1517.

The transceiver 1520 may be configured to modulate the signals that are to be transmitted by the transmit/receive element 1522 and to demodulate the signals that are received by the transmit/receive element 1522. As noted above, the WTRU 1502 may have multi-mode capabilities. Thus, the transceiver 1520 may include multiple transceivers for enabling the WTRU 1502 to communicate via multiple RATs, such as UTRA and IEEE 802.11, for example.

The processor 1518 of the WTRU 1502 may be coupled to, and may receive user input data from, the speaker/microphone 1524, the keypad 1526, and/or the display/touchpad 1528 (e.g., a liquid crystal display (LCD) display unit or organic light-emitting diode (OLED) display unit). The processor 1518 may also output user data to the speaker/microphone 1524, the keypad 1526, and/or the display/touchpad 1528. In addition, the processor 1518 may access information from, and store data in, any type of suitable memory, such as the non-removable memory 1530 and/or the removable memory 1532. The non-removable memory 1530 may include random-access memory (RAM), read-only memory (ROM), a hard disk, or any other type of memory storage device. The removable memory 1532 may include a subscriber identity module (SIM) card, a memory stick, a secure digital (SD) memory card, and the like. In other embodiments, the processor 1518 may access information from, and store data in, memory that is not physically located on the WTRU 1502, such as on a server or a home computer (not shown).

The processor 1518 may receive power from the power source 1534, and may be configured to distribute and/or control the power to the other components in the WTRU 1502. The power source 1534 may be any suitable device for powering the WTRU 1502. For example, the power source 1534 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 1518 may also be coupled to the GPS chipset 1536, which may be configured to provide location information (e.g., longitude and latitude) regarding the current location of the WTRU 1502. In addition to, or in lieu of, the information from the GPS chipset 1536, the WTRU 1502 may receive location information over the air interface 1515/1516/1517 from a base station (e.g., base stations 1514a, 1514b) and/or determine its location based on the timing of the signals being received from two or more nearby base stations. It will be appreciated that the WTRU 1502 may acquire location information by way of any suitable location-determination method while remaining consistent with an embodiment.

The processor 1518 may further be coupled to other peripherals 1538, which may include one or more software and/or hardware modules that provide additional features, functionality and/or wired or wireless connectivity. For example, the peripherals 1538 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 15C is a system diagram of the RAN 1503 and the core network 1506 according to an embodiment. As noted above, the RAN 1503 may employ a UTRA radio technology to communicate with the WTRUs 1502a, 1502b, 1502c over the air interface 1515. The RAN 1503 may also be in communication with the core network 1506. As shown in FIG. 15C, the RAN 1503 may include Node-Bs 1540a, 1540b, 1540c, which may each include one or more transceivers for communicating with the WTRUs 1502a, 1502b, 1502c over the air interface 1515. The Node-Bs 1540a, 1540b, 1540c may each be associated with a particular cell (not shown) within the RAN 1503. The RAN 1503 may also include RNCs 1542a, 1542b. It will be appreciated that the RAN 1503 may include any number of Node-Bs and RNCs while remaining consistent with an embodiment.

As shown in FIG. 15C, the Node-Bs 1540a, 1540b may be in communication with the RNC 1542a. Additionally, the Node-B 1540c may be in communication with the RNC 142b. The Node-Bs 1540a, 1540b, 1540c may communicate with the respective RNCs 1542a, 1542b via an lub interface. The RNCs 1542a, 1542b may be in communication with one another via an lur interface. Each of the RNCs 1542a, 1542b may be configured to control the respective Node-Bs 1540a, 1540b, 1540c to which it is connected. In addition, each of the RNCs 1542a, 1542b may be configured to carry out or support other functionality, such as outer loop power control, load control, admission control, packet scheduling, handover control, macrodiversity, security functions, data encryption, and the like.

The core network 1506 shown in FIG. 15C may include a media gateway (MGW) 1544, a mobile switching center (MSC) 1546, a serving GPRS support node (SGSN) 1548, and/or a gateway GPRS support node (GGSN) 1550. While each of the foregoing elements are depicted as part of the core network 1506, it will be appreciated that any one of these elements may be owned and/or operated by an entity other than the core network operator.

The RNC 1542a in the RAN 1503 may be connected to the MSC 1546 in the core network 1506 via an IuCS interface. The MSC 1546 may be connected to the MGW 1544. The MSC 1546 and the MGW 1544 may provide the WTRUs 1502a, 1502b, 1502c with access to circuit-switched networks, such as the PSTN 1508, to facilitate communications between the WTRUs 1502a, 1502b, 1502c and traditional land-line communications devices.

The RNC 1542a in the RAN 1503 may also be connected to the SGSN 1548 in the core network 1506 via an IuPS interface. The SGSN 1548 may be connected to the GGSN 1550. The SGSN 1548 and the GGSN 1550 may provide the WTRUs 1502a, 1502b, 1502c with access to packet-switched networks, such as the Internet 1510, to facilitate communications between and the WTRUs 1502a, 1502b, 1502c and IP-enabled devices.

As noted above, the core network 1506 may also be connected to the networks 1512, which may include other wired or wireless networks that are owned and/or operated by other service providers.

FIG. 15D is a system diagram of the RAN 1504 and the core network 1507 according to an embodiment. As noted above, the RAN 1504 may employ an E-UTRA radio technology to communicate with the WTRUs 1502a, 1502b, 1502c over the air interface 1516. The RAN 1504 may also be in communication with the core network 1507.

The RAN 1504 may include eNode-Bs 1560a, 1560b, 1560c, though it will be appreciated that the RAN 1504 may include any number of eNode-Bs while remaining consistent with an embodiment. The eNode-Bs 1560a, 1560b, 1560c may each include one or more transceivers for communicating with the WTRUs 1502a, 1502b, 1502c over the air interface 1516. In one embodiment, the eNode-Bs 1560a, 1560b, 1560c may implement MIMO technology. Thus, the eNode-B 1560a, for example, may use multiple antennas to transmit wireless signals to, and receive wireless signals from, the WTRU 1502a.

Each of the eNode-Bs 1560a, 1560b, 1560c may be associated with a particular cell (not shown) and may be configured to handle radio resource management decisions, handover decisions, scheduling of users in the uplink and/or downlink, and the like. As shown in FIG. 15D, the eNode-Bs 1560a, 1560b, 1560c may communicate with one another over an X2 interface.

The core network 1507 shown in FIG. 15D may include a mobility management gateway (MME) 1562, a serving gateway 1564, and a packet data network (PDN) gateway 1566. While each of the foregoing elements are depicted as part of the core network 1507, it will be appreciated that any one of these elements may be owned and/or operated by an entity other than the core network operator.

The MME 1562 may be connected to each of the eNode-Bs 1560a, 1560b, 1560c in the RAN 1504 via an S1 interface and may serve as a control node. For example, the MME 1562 may be responsible for authenticating users of the WTRUs 1502a, 1502b, 1502c, bearer activation/deactivation, selecting a particular serving gateway during an initial attach of the WTRUs 1502a, 1502b, 1502c, and the like. The MME 1562 may also provide a control plane function for switching between the RAN 1504 and other RANs (not shown) that employ other radio technologies, such as GSM or WCDMA.

The serving gateway 1564 may be connected to each of the eNode-Bs 1560a, 1560b, 1560c in the RAN 1504 via the S1 interface. The serving gateway 1564 may generally route and forward user data packets to/from the WTRUs 1502a, 1502b, 1502c. The serving gateway 1564 may also perform other functions, such as anchoring user planes during inter-eNode B handovers, triggering paging when downlink data is available for the WTRUs 1502a, 1502b, 1502c, managing and storing contexts of the WTRUs 1502a, 1502b, 1502c, and the like.

The serving gateway 1564 may also be connected to the PDN gateway 1566, which may provide the WTRUs 1502a, 1502b, 1502c with access to packet-switched networks, such as the Internet 1510, to facilitate communications between the WTRUs 1502a, 1502b, 1502c and IP-enabled devices.

The core network 1507 may facilitate communications with other networks. For example, the core network 1507 may provide the WTRUs 1502a, 1502b, 1502c with access to circuit-switched networks, such as the PSTN 1508, to facilitate communications between the WTRUs 1502a, 1502b, 1502c and traditional land-line communications devices. For example, the core network 1507 may include, or may communicate with, an IP gateway (e.g., an IP multimedia subsystem (IMS) server) that serves as an interface between the core network 1507 and the PSTN 1508. In addition, the core network 1507 may provide the WTRUs 1502a, 1502b, 1502c with access to the networks 1512, which may include other wired or wireless networks that are owned and/or operated by other service providers.

FIG. 15E is a system diagram of the RAN 1505 and the core network 1509 according to an embodiment. The RAN 1505 may be an access service network (ASN) that employs IEEE 802.16 radio technology to communicate with the WTRUs 1502a, 1502b, 1502c over the air interface 1517. As will be further discussed below, the communication links between the different functional entities of the WTRUs 1502a, 1502b, 1502c, the RAN 1505, and the core network 1509 may be defined as reference points.

As shown in FIG. 15E, the RAN 1505 may include base stations 1580a, 1580b, 1580c, and an ASN gateway 1582, though it will be appreciated that the RAN 1505 may include any number of base stations and ASN gateways while remaining consistent with an embodiment. The base stations 1580a, 1580b, 1580c may each be associated with a particular cell (not shown) in the RAN 1505 and may each include one or more transceivers for communicating with the WTRUs 1502a, 1502b, 1502c over the air interface 1517. In one embodiment, the base stations 1580a, 1580b, 1580c may implement MIMO technology. Thus, the base station 1580a, for example, may use multiple antennas to transmit wireless signals to, and receive wireless signals from, the WTRU 1502a. The base stations 1580a, 1580b, 1580c may also provide mobility management functions, such as handoff triggering, tunnel establishment, radio resource management, traffic classification, quality of service (QoS) policy enforcement, and the like. The ASN gateway 1582 may serve as a traffic aggregation point and may be responsible for paging, caching of subscriber profiles, routing to the core network 1509, and the like.

The air interface 1517 between the WTRUs 1502a, 1502b, 1502c and the RAN 1505 may be defined as an R1 reference point that implements the IEEE 802.16 specification. In addition, each of the WTRUs 1502a, 1502b, 1502c may establish a logical interface (not shown) with the core network 1509. The logical interface between the WTRUs 1502a, 1502b, 1502c and the core network 1509 may be defined as an R2 reference point, which may be used for authentication, authorization, IP host configuration management, and/or mobility management.

The communication link between each of the base stations 1580a, 1580b, 1580c may be defined as an R8 reference point that includes protocols for facilitating WTRU handovers and the transfer of data between base stations. The communication link between the base stations 1580a, 1580b, 1580c and the ASN gateway 1582 may be defined as an R6 reference point. The R6 reference point may include protocols for facilitating mobility management based on mobility events associated with each of the WTRUs 1502a, 1502b, 1502c.

As shown in FIG. 15E, the RAN 1505 may be connected to the core network 1509. The communication link between the RAN 1505 and the core network 1509 may defined as an R3 reference point that includes protocols for facilitating data transfer and mobility management capabilities, for example. The core network 1509 may include a mobile IP home agent (MIP-HA) 1584, an authentication, authorization, accounting (AAA) server 1586, and a gateway 1588. While each of the foregoing elements are depicted as part of the core network 1509, it will be appreciated that any one of these elements may be owned and/or operated by an entity other than the core network operator.

The MIP-HA may be responsible for IP address management, and may enable the WTRUs 1502a, 1502b, 1502c to roam between different ASNs and/or different core networks. The MIP-HA 1584 may provide the WTRUs 1502a, 1502b, 1502c with access to packet-switched networks, such as the Internet 1510, to facilitate communications between the WTRUs 1502a, 1502b, 1502c and IP-enabled devices. The AAA server 1586 may be responsible for user authentication and for supporting user services. The gateway 1588 may facilitate interworking with other networks. For example, the gateway 1588 may provide the WTRUs 1502a, 1502b, 1502c with access to circuit-switched networks, such as the PSTN 1508, to facilitate communications between the WTRUs 1502a, 1502b, 1502c and traditional land-line communications devices. In addition, the gateway 1588 may provide the WTRUs 1502a, 1502b, 1502c with access to the networks 1512, which may include other wired or wireless networks that are owned and/or operated by other service providers.

Although not shown in FIG. 15E, it will be appreciated that the RAN 1505 may be connected to other ASNs and the core network 1509 may be connected to other core networks. The communication link between the RAN 1505 the other ASNs may be defined as an R4 reference point, which may include protocols for coordinating the mobility of the WTRUs 1502a, 1502b, 1502c between the RAN 1505 and the other ASNs. The communication link between the core network 1509 and the other core networks may be defined as an R5 reference, which may include protocols for facilitating interworking between home core networks and visited core networks.

Although features and elements are described above in particular combinations, one of ordinary skill in the art will appreciate that each feature or element may be used alone or in any combination with the other features and elements. Other than the 802.11 protocols described herein, the features and elements described herein may be applicable to other wireless systems. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, optical media such as CD-ROM disks, and digital versatile disks (DVDs). A processor in association with software may be used to implement a radio frequency transceiver for use in a WTRU, WTRU, terminal, base station, RNC, or any host computer.

1. A method associated with providing device security, the method comprising:
receiving, by a WTRU, a software vulnerability ticket (SVT) comprising a software update, wherein the SVT comprises at least one of a location to fetch software update information, content of the software update information, or an indication that no update is associated with the SVT;
storing the SVT in a memory associated with the WTRU;
determining, by a security agent associated with the WTRU, whether the WTRU has a fresh SVT, wherein the security agent runs in a secure execution environment on the WTRU, and wherein the secure execution environment is not dependent on a main operating system associated with the WTRU;
on a condition that it is determined that the WTRU has the fresh SVT, performing a vulnerability check and security update; and
on a condition that it is determined that the WTRU does not have the fresh SVT, executing a recovery procedure.

2. The method of claim 1, wherein the security agent associated with the WTRU determines that the WTRU has the fresh SVT when it is determined that a latest stored SVT was received within a predefined threshold time period or was received according to a predefined sequence.

3. The method of claim 1, wherein the security agent associated with the WTRU determines that the WTRU does not have the fresh SVT when it is determined that a latest stored SVT was not received within a predefined threshold time period or was not received according to a predefined sequence or that the WTRU does not have a stored SVT.

4. The method of claim 1, wherein the SVT comprises at least one of a time stamp of the SVT, an identification number of the SVT, or one or more signatures of vulnerabilities.

5. The method of claim 1, wherein the SVT comprises a digital signature of the sender of the SVT.

6. The method of claim 5, wherein the digital signature comprises a public key algorithm and a private key of the sender of the SVT.

7. The method of claim 1, wherein the recovery procedure comprises the WTRU retrieving the fresh SVT, and wherein retrieving the fresh SVT comprises the security agent or a non-secure portion of the WTRU accessing a network to retrieve the fresh SVT.

8. (canceled)

9. The method of claim 1, wherein the security agent runs in the secure execution environment of the WTRU according to a predefined period.

10. The method of claim 9, wherein a watchdog enforcement function defines the predefined period.

11. The method of claim 1, wherein the security agent associated with the WTRU determines whether the WTRU has the fresh SVT based on an index value stored in a non-volatile memory associated with the WTRU.

12. A wireless transmit/receive unit (WTRU) comprising:
a transceiver;
a memory; and
a processor, wherein the WTRU is configured to:
receive software vulnerability ticket (SVT) comprising a software update, wherein the SVT comprises at least one of a location to fetch software update information, a content of the software update information, or an indication that no update is associated with the SVT;
store the SVT in the memory;
determine, by a security agent associated with the WTRU, whether the received SVT is a fresh SVT, wherein the security agent runs in a secure execution environment on the WTRU, and wherein the secure execution environment is not dependent on a main operating system associated with the WTRU;
on a condition that it is determined that the received SVT is the fresh SVT, perform a vulnerability check and security update; and
on a condition that it is determined that the received SVT is not the fresh SVT, execute a recovery procedure.

13. The WTRU of claim 12, wherein the security agent associated with the WTRU determines that the WTRU has the fresh SVT when it is determined that a latest stored SVT was received within a predefined threshold time period or was received according to a predefined sequence.

14. The WTRU of claim 12, wherein the security agent associated with the WTRU determines that the WTRU does not have the fresh SVT when it is determined that a latest stored SVT was not received within a predefined threshold time period or was not received according to a predefined sequence or that the WTRU does not have a stored SVT.

15. The WTRU of claim 12, wherein the SVT comprises at least one of a time stamp of the SVT, an identification number of the SVT, or one or more signatures of vulnerabilities.

16. The WTRU of claim 12, wherein the SVT comprises a digital signature of the sender of the SVT.

17. The WTRU of claim 16, wherein the digital signature comprises a public key algorithm and a private key of the sender of the SVT.

18. The WTRU of claim 12, wherein the recovery procedure comprises the WTRU being configured to retrieve the fresh SVT, and wherein being configured to retrieve the fresh SVT comprises the security agent or a non-secure portion of the WTRU being configured to access a network to retrieve the fresh SVT.

19. (canceled)

20. The WTRU of claim 12, wherein the security agent runs in the secure execution environment of the WTRU according to a predefined period.

21. The WTRU of claim 20, wherein a watchdog enforcement function defines the predefined period.

22. The WTRU of claim 12, wherein the security agent associated with the WTRU determines whether the WTRU has the fresh SVT based on an index value stored in a non-volatile memory associated with the WTRU.
